(19) United States
(12) Patent Application Publication
(10) Pub. No.: US 2026/0298098 A1
(43) Pub. Date: Oct. 1, 2026

(54) TURBINE ENGINE COMPONENT WITH COOLING APERTURE

(71) Applicant: General Electric Company, Evendale, OH (US)

(72) Inventors: Emily Hope Davenport, Lone Tree, CO (US); Zachary Daniel Webster, Liberty Township, OH (US); Daniel Endecott Osgood, Loveland, OH (US); Ricardo Caraballo, Maineville, OH (US); Matthew Alan Smith, Dayton, OH (US); Catherine Marie Rucki, West Chester, OH (US); Susan Emily Schulz, Colerain Township, OH (US); Jorge Rodrigo Quintero Badillo, Loveland, OH (US)

(21) Appl. No.: 19/578,074

(22) Filed: Mar. 25, 2026

Related U.S. Application Data
(60) Provisional application No. 63/777,096, filed on Mar. 25, 2025.
(60) Provisional application No. 63/777,106, filed on Mar. 25, 2025.

(51) Int. Cl. F01D 5/18

(52) U.S. Cl. CPC F01D 5/186; F05D 2200/14; F05D 2240/301; F05D 2260/202

(57) ABSTRACT

A turbine blade assembly for a gas turbine engine can include a cooling aperture for local thermal heat management and to provide a cooling film along an exterior of the airfoil. The cooling aperture is positioned within an outer wall of an airfoil defining an interior for the airfoil and a cooling circuit provides a cooling fluid flow to the cooling aperture. The cooling aperture includes a cavity at least partially defined by the outer surface, an inner surface, a first side, and a second side. The cavity exhausts at a diffuser outlet extending between the first side and the second side.

### RELATED APPLICATION

This patent claims the benefit of U.S. Provisional Patent Application No. 63/777,096, titled “TURBINE ENGINE COMPONENT WITH COOLING APERTURE,” which was filed on Mar. 25, 2025, and U.S. Provisional Patent Application No. 63/777,106, titled “TURBINE ENGINE COMPONENT WITH A COOLING APERTURE,” which was filed on Mar. 25, 2025. U.S. Provisional Patent Application Nos. 63/777,096 and 63/777,106 are incorporated herein by reference in their entireties. Priority to U.S. Provisional Patent Application No. 63/777,096 and U.S. Provisional Patent Application No. 63/777,106 is hereby claimed.

### TECHNICAL FIELD

The present subject matter relates generally to a turbine engine component, such as an airfoil of a turbine blade assembly, having a cooling aperture for cooling the turbine engine component.

### BACKGROUND

A gas turbine engine typically includes a fan and a turbomachine. The turbomachine generally includes an inlet, one or more compressors, a combustor, and at least one turbine. The compressors compress air which is channeled to the combustor where it is mixed with fuel. The mixture is then ignited to generate hot combustion gases. The combustion gases are channeled to the turbine(s) which extracts energy from the combustion gases for powering the compressor(s), as well as for producing useful work to propel an aircraft in flight or to power a load, such as an electrical generator.

During operation of the gas turbine engine, various systems may generate a relatively large amount of heat. For example, a substantial amount of heat may be generated during operation of the thrust generating systems, lubrication systems, electric motors and/or generators, hydraulic systems, or other systems. Accordingly, a cooling structure within the engine components located in the various systems would be advantageous in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of a gas turbine engine, in accordance with an aspect of the present disclosure.

FIG. 2 is a perspective view of an engine component in the form of a turbine blade assembly having an airfoil with a cooling aperture, in accordance with an aspect of the present disclosure.

FIG. 3 is a perspective view of the turbine blade assembly of FIG. 2, with the cooling aperture shown as four cooling apertures illustrating various orientations and arrangements for the four cooling apertures, in accordance with an aspect of the present disclosure.

FIG. 4 is an enlarged view of the cooling aperture of FIG. 2 illustrating a cavity within the outer wall containing a pair of metering holes and a pin, in accordance with an aspect of the present disclosure.

FIG. 5 is the enlarged view of the cooling aperture of FIG. 4 illustrating a cavity angle defined between a first side and a second side, and illustrating flow components exhausting from a diffuser outlet, in accordance with an aspect of the present disclosure.

FIG. 6A is an enlarged schematic view of a cooling aperture having a diffuser outlet with a bend, in accordance with an aspect of the present disclosure.

FIG. 6B is an enlarged schematic view of a cooling aperture having a diffuser outlet with linear portions meeting at a corner, in accordance with an aspect of the present disclosure.

FIG. 7 is an enlarged schematic view of a cooling aperture illustrating a positioning for a metering hole within a cavity for the cooling aperture, in accordance with an aspect of the present disclosure.

FIG. 8 is an enlarged schematic view of a cooling aperture illustrating a spacing for a pair of metering holes within a cavity for the cooling aperture, in accordance with an aspect of the present disclosure.

FIG. 9A is an enlarged schematic view of a cooling aperture including a pin having an arrangement relative to a diffuser outlet, in accordance with an aspect of the present disclosure.

FIG. 9B is an enlarged schematic view of a cooling aperture including multiple pins having an arrangement relative to a diffuser outlet, in accordance with an aspect of the present disclosure.

FIG. 10 is a perspective view of an airfoil including a cooling aperture, in accordance with an aspect of the present disclosure.

FIG. 11 is a cross-sectioned perspective view of a cooling aperture illustrating a curvature for a first side and a second side curving toward a diffuser outlet, in accordance with an aspect of the present disclosure.

FIG. 12 is a perspective view of an airfoil including a cooling aperture and a cooling hole, in accordance with an aspect of the present disclosure.

FIG. 13 is a perspective view of an airfoil including a cooling aperture and a set of cooling holes, in accordance with an aspect of the present disclosure.

FIG. 14 is a perspective view of two example cooling apertures with combined diffuser outlets.

### DETAILED DESCRIPTION

Aspects of the disclosure herein are directed to a cooling aperture located within an engine component, such as an airfoil, and more specifically to a cooling aperture where the performance of the cooling aperture is a function of geometric parameters that drive heat transfer, cooling film generation, and pressure drop resultant of a cooling fluid passed through the cooling aperture. Such a cooling aperture can be a cooling hole or a film hole, in non-limiting examples. For purposes of illustration, the present disclosure will be described with respect to the cooling aperture located within an airfoil of a turbine for a gas turbine engine, such as a turbine blade provided within a turbine section of the gas turbine engine. It will be understood, however, that aspects of the disclosure herein are not so limited and may have general applicability within an engine, including compressors or fans, as well as in non-aircraft applications or other turbine environments, such as other mobile applications and non-mobile industrial, commercial, and residential applications.

Reference will now be made in detail to the architecture, and in particular the cooling aperture, located within a turbine blade, one or more examples of which are illustrated in the accompanying drawings. The detailed description uses numerical and letter designations to refer to features in the drawings.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first,” “second,” “third,” etc. may be used interchangeably to distinguish one component from another and are not intended to signify location or importance of the individual components.

The terms “forward” and “aft” refer to relative positions within a gas turbine engine or vehicle, and are based on a normal operational attitude of the gas turbine engine or vehicle. More particularly, forward and aft are used herein with reference to a direction of travel and a direction of propulsive thrust of the gas turbine engine or vehicle.

As used herein, the term “upstream” refers to a direction that is opposite the fluid flow direction, and the term “downstream” refers to a direction that is in the same direction as the fluid flow. The term “fore” or “forward” means in front of something and “aft” or “rearward” means behind something. For example, when used in terms of fluid flow, fore/forward can mean upstream and aft/rearward can mean downstream.

The term “fluid” may be a gas or a liquid, or multi-phase. The term “fluid communication” means that a fluid is capable of making the connection between the areas specified.

Connection references (e.g., attached, coupled, connected, and joined) are to be construed broadly and can include intermediate structural elements between a collection of elements and relative movement between elements unless otherwise indicated. As such, connection references do not necessarily infer that two elements are directly connected and in fixed relation to one another. The exemplary drawings are for purposes of illustration only and the dimensions, positions, order, and relative sizes reflected in the drawings attached hereto can vary.

The singular forms “a,” “an,” and “the” include plural references unless the context clearly dictates otherwise. Furthermore, as used herein, the term “set” or a “set” of elements can be any number of elements, including only one.

In reference to a turbine blade assembly, a radial direction (denoted “Rd”) is a direction that is perpendicular to a base plane defined by a base of a shank of the turbine blade assembly; an axial direction (denoted “Ad”) is a direction perpendicular to a shank leading edge plane defined by a shank leading edge of the shank of the turbine blade assembly; and tangential direction (denoted “Td”) is a direction that is perpendicular to the radial direction (Rd) and the axial direction (Ad).

A “minimum hydraulic diameter” (dₕ), as used herein, is in reference to the smallest or minimum hydraulic diameter of at least one metering hole providing the cooling fluid flow to a cavity. Hydraulic diameter is a commonly used term when handling flow of fluids in flow passages where such flow passages may be circular or non-circular holes, tubes, apertures, channels, or conduits in non-limiting examples. The minimum hydraulic diameter can be calculated as

$${d}_{h} = \frac{4 a}{p}$$

where “a” is the smallest cross-sectional area of the flow passage and “p” is the wetted perimeter of the cross-section. Where a cooling aperture utilizes one metering hole, the minimum hydraulic diameter (dₕ) for the cooling aperture is the same as the (dₕ) for the metering hole. Where a cooling aperture utilizes more than one metering hole, the minimum hydraulic diameter (dₕ) for the cooling aperture is an average of the minimum hydraulic diameters of the metering holes.

An “outlet edge distance” (d_{edge}), as used herein, is defined as the minimum distance between any position of a diffuser outlet for a cooling aperture, and the nearest of a leading edge, a trailing edge, a root, or a tip of an airfoil upon which the cooling aperture is arranged. In a system where the cooling aperture is arranged on a component, such as an airfoil, shroud, or combustor liner in non-limiting examples, the “outlet edge distance” is defined as the minimum distance between any position of the diffuser outlet and the nearest edge for such a component. The “outlet edge distance” (d_{edge}) can be defined in either the span-wise direction or the chord-wise direction, while measurements in a radial direction (Rd) or an axial direction (Ad) are within the scope of this disclosure. Additional directions offset from span-wise, chord-wise, radial, or axial are contemplated, where the geometry or orientation of the airfoil or the cooling aperture necessitates a minimum distance that is offset from span-wise, chord-wise, radial, or axial. Such an offset can be defined by a non-zero angle relative to spanwise, chord-wise, radial, or axial in non-limiting examples.

A “film hole radial distance” (d_{radial}), as used herein, is defined as the minimum distance between the cooling aperture and the nearest film hole among a common surface measured in the radial direction (Rd). The “film hole radial distance” (d_{radial}) only considers spacing measured in the radial direction, and does not consider any other spacing of the film hole from the diffuser outlet, such as spacing in an axial direction or a chord-wise direction.

A “cavity angle” (α), as used herein, is in reference to an angle defined between a first side and a second side of a cooling aperture at least partially defining a cavity and exhausting at a diffuser outlet. The first side and the second side meet at a junction. A first axis extends between the junction and where the first side meets the diffuser outlet, and a second axis extends between the junction and where the second side meets the diffuser outlet. The “cavity angle” (α) can be defined as the angle between the first axis and the second axis.

A “spacing distance” (s) is defined as the distance between center points of any pair of metering holes providing a cooling fluid to a cavity of a cooling aperture. The center points can be arranged along an outlet of each of the pair of metering holes where the pair of metering holes meet the cavity of the cooling aperture.

An “outlet width” (Ow), as used herein, is in reference to a width of a diffuser outlet for a cooling aperture. The “outlet width” (Ow) is defined as the distance between an inner edge and an outer edge defining the diffuser outlet. Where the distance between the inner edge and the outer edge is constant along the diffuser outlet, the “outlet width” (W) is the distance between the inner edge and the outer edge at any position along the diffuser outlet. Where the distance between the inner edge and the outer edge is non-constant, the “outlet width” (Ow) is an average distance between the inner edge and the outer edge along the length of the diffuser outlet.

A “radius of curvature” (R), as used herein, is in reference to a radius defined by a curvature of a curved body or structure.

In certain exemplary embodiments of the present disclosure, a gas turbine engine defining a centerline and a circumferential direction is provided. The gas turbine engine may generally include a turbomachine and a rotor assembly. The rotor assembly may be driven by the turbomachine. The turbomachine, the rotor assembly, or both may define a substantially annular flow path relative to the centerline of the gas turbine engine. The gas turbine engine includes an airfoil, by way of non-limiting example a turbine blade positioned within the flow path, with at least one cooling aperture provided within. The airfoil, described herein, can be one among a plurality of airfoils provided circumferentially about the centerline or be partially provided about a portion of the centerline.

The objective, when designing an airfoil, can be generally stated as satisfying a minimum heat transfer capability or minimum cooling film capability within an acceptable amount of pressure loss across the airfoil. Key factors to consider include the available fluid volume and associated geometrical constraints for the at least one cooling aperture design and the operational limits of the engine component.

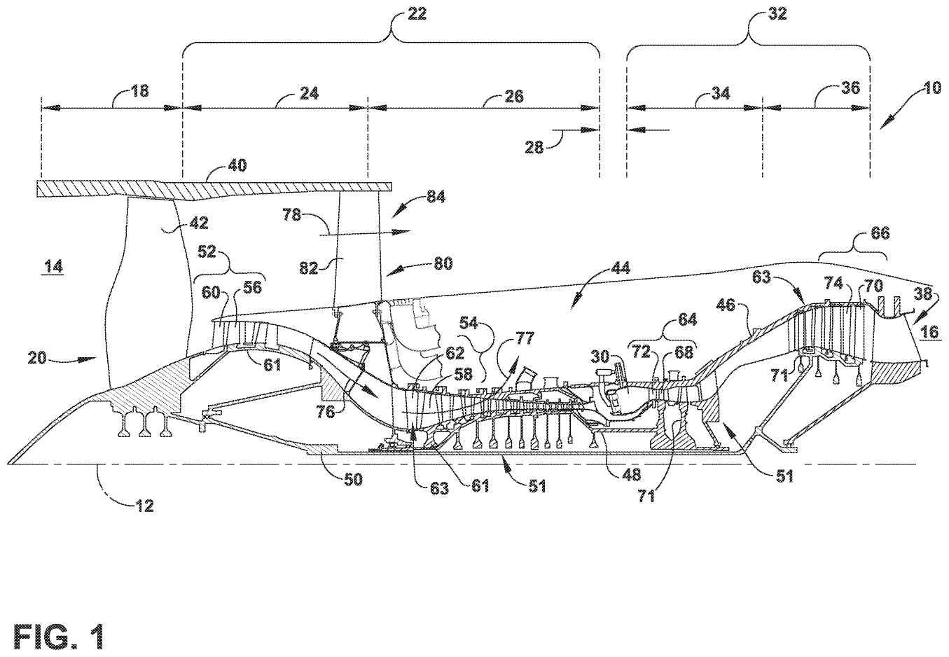

The inventors' practice has proceeded in the manner of designing an airfoil, modifying the airfoil with the addition of at least one cooling aperture, and redesigning the airfoil with the at least one cooling aperture to meet heat transfer, cooling film, and pressure requirements, then calculating and checking the amount of heat transfer, temperature, and pressure, and repeating the process, etc. during the design of several different types of turbomachines, such as those shown in FIG. 1.

FIG. 1 is a schematic cross-sectional diagram of a gas turbine engine 10 for an aircraft. The gas turbine engine 10 has a generally longitudinally extending axis or centerline 12 extending from a forward 14 to an aft 16. The gas turbine engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including an HP turbine 34, and an LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the gas turbine engine 10, which generates combustion gases. The core 44 is surrounded by a core casing 46, which can be coupled with the fan casing 40.

An HP shaft or spool 48 disposed coaxially about the centerline 12 of the gas turbine engine 10 drivingly connects the HP turbine 34 to the HP compressor 26. An LP shaft or spool 50 is disposed coaxially about the centerline 12 and positioned within the larger diameter annular HP spool 48. The LP shaft or spool 50 drivingly connects the LP turbine 36 to the LP compressor 24 and fan 20. The HP and LP spools 48, 50 are rotatable about the centerline 12 and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating compressor blades 56, 58. It is noted that the number of stages, blades, vanes, and compressor stages shown in FIG. 1 were selected for illustrative purposes only, and that other numbers are possible.

The compressor blades 56, 58 for a stage of the compressor can be mounted to a disk 61, which is mounted to the corresponding one of the HP and LP spools 48, 50, with each stage having its own disk 61. In an alternative, non-limiting example, the compressor blades 56, 58 may be part of a blisk, rather than being mounted to a disk. The static compressor vanes 60, 62 for a stage of the compressor can be mounted to the core casing 46 in a circumferential arrangement.

The HP turbine 34 and the LP turbine 36 respectively include a plurality of stages as turbine stages 64, 66 in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in an annular ring and can extend radially outwardly relative to the centerline 12, from a blade platform to a blade tip, while the corresponding static turbine vanes 72, 74 are positioned upstream of and adjacent to the rotating turbine blades 68, 70. It is noted that the number of stages, blades, vanes, and turbine stages shown in FIG. 1 were selected for illustrative purposes only, and that other numbers are possible.

The turbine blades 68, 70 for a stage of the turbine can be mounted to a disk 71, which is mounted to the corresponding one of the HP and LP spools 48, 50, with each stage having a disk 71. The static turbine vanes 72, 74 for a stage of the turbine can be mounted to the core casing 46 in a circumferential arrangement.

Complimentary to the rotor 51, the stationary portions of the gas turbine engine 10, such as the static compressor and turbine vanes 60, 62, 72, 74 among the compressor and turbine sections 22, 32 are also referred to individually or collectively as a stator 63. As such, the stator 63 can refer to the combination of non-rotating elements throughout the gas turbine engine 10.

In operation, the airflow exiting the fan section 18 is split such that a portion of the airflow is channeled into the LP compressor 24 as a pressurized air 76, while a remaining portion of the airflow bypasses the core 44 as bypass airflow 78. The pressurized air 76 passes to the HP compressor 26, which further pressurizes the air. The pressurized air 76 from the HP compressor 26 is mixed with fuel in the combustor 30 and ignited, which generates combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the gas turbine engine 10 via the exhaust section 38. The driving of the LP turbine 36 drives the LP spool 50 to rotate the fan 20 and the LP compressor 24.

A portion of the pressurized air 76 can be drawn from the compressor section 22 as a bleed airflow 77. The bleed airflow 77 can be drawn from the pressurized air 76 and provided to engine components requiring cooling. The temperature of pressurized air 76 entering and exiting the combustor 30 is significantly increased. As such, cooling provided by the bleed airflow 77 is supplied to downstream turbine components (e.g., the turbine blade 68) subjected to the heightened temperature environments.

The bypass airflow 78 bypasses the LP compressor 24 and core 44 and exits the gas turbine engine 10 through a stationary vane row. The stationary vane row can be an outlet guide vane assembly 80 comprising a plurality of airfoil guide vanes 82 at a fan exhaust side 84. More specifically, the plurality of airfoil guide vanes 82 can be a circumferential row of radially extending airfoil guide vanes utilized adjacent the fan section 18 to exert some directional control of the bypass airflow 78.

Some of the air supplied by the fan 20 can bypass the core 44 and be used for cooling of portions, especially hot portions, of the gas turbine engine 10, and/or used to cool or power other aspects of the aircraft upon which the gas turbine engine 10 is mounted. In the context of the gas turbine engine 10, the hot portions of the engine are normally downstream of the combustor 30, especially the turbine section 32, with the HP turbine 34 being the hottest portion as it is directly downstream of the combustion section 28. Other sources of cooling fluid can be, but are not limited to, the bleed airflow 77 from the LP compressor 24 or the HP compressor 26.

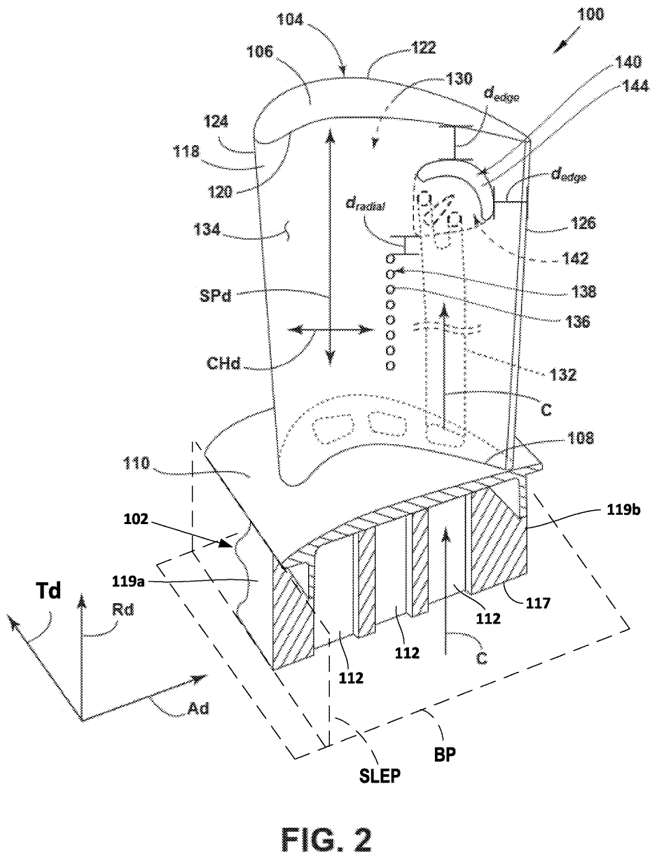

FIG. 2 is a perspective view of an engine component in the form of an a turbine blade assembly 100, such as the turbine blade 68, 70 of the gas turbine engine 10 from FIG. 1.

The turbine blade assembly 100 includes a shank 102 and an airfoil 104. The airfoil 104 extends between a tip 106 and a root 108 to define a span-wise direction (SPd) extending therebetween. The airfoil 104 mounts to the shank 102 at a platform 110 at the root 108. The shank 102 and the platform 110 are partially cross-sectioned in FIG. 2. When multiple airfoils are circumferentially arranged in side-by-side relationship, the platform 110 helps to radially contain the gas turbine engine mainstream airflow and forms the radially inner wall of an annulus through which the air flows. The shank 102 can be configured to mount to the disk 71 on the gas turbine engine 10 of FIG. 1, in a non-limiting example. In the illustrated example, the shank 102 has a dovetail shape, which is shaped to be inserted into a corresponding slot in the disk 71. The shank 102 is oriented to mount to the disk 71 along an axial direction (Ad). The shank 102 further includes at least one inlet passage, shown as three inlet passages 112, extending through the shank 102 to provide internal fluid communication with the airfoil 104.

For the sake of reference, a set of relative reference directions, along with a coordinate system can be applied to the turbine blade assembly 100. The shank 102 extends between a base 117 and the platform 110. The base 117 of the shank 102 is a flat surface that defines a plane, referred to herein as the base plane (denoted “BP”). A radial direction (denoted “Rd”) of the turbine blade assembly 100 is a direction that is perpendicular to the base plane BP. Further, the shank 102 extends between a shank leading edge 119a and a shank trailing edge 119b. The shank leading edge 119a is a flat surface that defines a plane, referred herein as the shank leading edge plane (denoted “SLEP”). An axial direction (denoted “Ad”) of the turbine blade assembly 100 is a direction that is perpendicular to the shank leading edge plane SLEP. A tangential direction (denoted “Td”) is a direction perpendicular to both the radial direction Rd and the axial direction Ad.

The airfoil 104 includes an outer wall 118 with a concave-shaped pressure side 120 and a convex-shaped suction side 122, which collectively define an airfoil cross-sectional shape. The airfoil 104 extends between a leading edge 124 and a trailing edge 126 to define a chord-wise direction (CHd) therebetween. An interior 130 of the airfoil 104 can include at least one cooling circuit 132, illustrated in broken line. The at least one cooling circuit 132 is fluidly coupled with the inlet passage 112 to provide a cooling fluid flow (C) to the interior 130. The outer wall 118 has an interior surface, which defines or surrounds the interior 130 (i.e., the cooling circuit 132), and an exterior surface 134 opposite the interior surface. At least one film hole 136 extends through the outer wall 118 and is arranged as a row of film holes 138, while a non-row arrangement for the at least one film hole 136 is contemplated. The at least one film hole 136 extends through the outer wall 118 between the at least one cooling circuit 132 and an exterior surface 134 of the airfoil 104. As such, the cooling fluid flow (C) in the at least one cooling circuit 132 of the airfoil 104 is vented or exhausted through the at least one film hole 136 and into the flow stream of the engine. As the cooling fluid flow (C) passes outwardly through the film hole(s) 136, the cooling fluid flow (C) forms a thermal barrier of relatively cool fluid (also called a cooling film) around the airfoil 104, which helps reduce the temperature of the turbine blade assembly 100. The airfoil 104 can include any number of film hole(s) 136, and the film hole(s) 136 can be distributed in various locations along the exterior surface 134 of the airfoil 104.

The airfoil 104 also includes a cooling aperture 140 on the outer wall 118, and which can be located along any portion of the outer wall 118. The cooling aperture 140 defines a cavity 142 in the outer wall 118 that exhausts at a diffuser outlet 144. The cooling fluid flow (C) can be supplied from the at least one cooling circuit 132 to the cavity 142 of the cooling aperture 140, where the cooling fluid flow (C) can exhaust from the diffuser outlet 144, spreading along a hot surface of the airfoil as the exterior surface 134 of the outer wall 118, such as exhausting as a cooling film in a non-limiting example. As explained in further detail herein, the cooling aperture 140 provides a wider range of directional flow components to improve film effectiveness. The cooling aperture 140 also reduces or eliminates the requirement for local tip holes. In additional non-limiting examples, one or more cooling apertures 140 can be positioned on either or both of the pressure side 120 and the suction side 122, as well as the platform 110 or the tip 106, such as at or coupled to a tip plenum.

The outlet edge distance (d_{edge}) is defined as the minimum distance between the diffuser outlet 144 and the nearest edge, where the nearest edge can be any one of the leading edge 124, the trailing edge 126, the root 108, or the tip 106. In additional non-limiting examples, the outlet edge distance (d_{edge}) can be measured to the nearest boundary, such as the boundary between the airfoil and an outer or inner wall, like the platform 110, or an inner or outer band for a nozzle. In another non-limiting example, the minimum distance can be arranged parallel to one of the span-wise direction (SPd) or the chord-wise direction (CHd) in non-limiting examples. While two outlet edge distances (d_{edge}) are depicted in FIG. 2, it should be understood that only one minimum distance will be defined, and that FIG. 2 is merely illustrating two separate examples where the outlet edge distance (d_{edge}) is measured relative to either of the trailing edge 126 or the tip 106. Where the component is a component other than an airfoil, the outlet edge distance (d_{edge}) can be defined as the minimum distance to the nearest edge along the hot surface as the exterior surface 134.

A film hole radial distance (d_{radial}) is defined as the minimum distance between the at least one film hole 136 and the cooling aperture 140 as measured in the radial direction (Rd). Where the at least one film hole 136 includes multiple film holes, such as a row of film holes 138, the film hole radial distance (d_{radial}) can be measured relative to the nearest film hole of the row of film holes 138.

Materials used to form the airfoil 104 and the cooling aperture 140, as well as the turbine blade assembly 100 or portions thereof, can include, but are not limited to, steel, refractory metals such as titanium, or superalloys based on nickel, cobalt, or iron, and ceramic matrix composites. The substrate and cooling architecture can be formed by a variety of methods, including additive manufacturing, casting, electroforming, or direct metal laser melting, in non-limiting examples. As used herein, an “additively manufactured” component will refer to a component formed by an additive manufacturing (AM) process, wherein the component is built layer-by-layer by successive deposition of material. AM is an appropriate name to describe the technologies that build 3D objects by adding layer-upon-layer of material, whether the material is plastic, ceramic, or metal. AM technologies can utilize a computer, 3D modeling software (Computer Aided Design or CAD), machine equipment, and layering material. Once a CAD model is produced, the AM equipment can read in data from the CAD file and lay down or add successive layers of liquid, powder, sheet material or other material, in a layer-upon-layer fashion to fabricate a 3D object representative of the CAD model. It should be understood that the term “additive manufacturing” encompasses many technologies including subsets like 3D Printing, Rapid Prototyping (RP), Direct Digital Manufacturing (DDM), layered manufacturing and additive fabrication. Non-limiting examples of additive manufacturing that can be utilized to form an additively manufactured component include powder bed fusion, vat photopolymerization, binder jetting, material extrusion, directed energy deposition, material jetting, or sheet lamination. It is also contemplated that a process utilized could include printing a negative of the part, either by a refractory metal, ceramic, or printing a plastic, and then using that negative to cast the component.

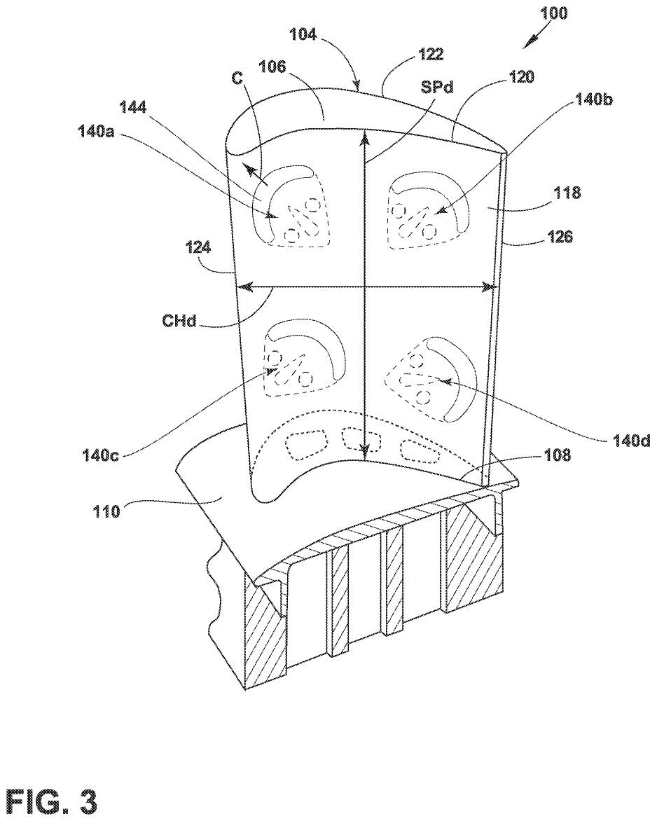

FIG. 3 shows an example of the airfoil 104 for the turbine blade assembly 100 having four cooling apertures 140a-d. As can be appreciated, the cooling apertures 140a-d can have any orientation. Furthermore, the cooling apertures 140a-d can be positioned at any portion of the airfoil 104 where heat transfer cooling and film cooling are desirable. The first cooling aperture 140a is arranged relatively nearer to the leading edge 124 and the tip 106, as compared with the remaining cooling apertures 140b-d. The orientation for the first cooling aperture 140a can be positioned such that the cooling fluid flow (C) exhausting from the diffuser outlet 144 is directed toward where the leading edge 124 meets the tip 106, while an orientation having the cooling fluid flow (C) toward the leading edge 124, the tip 106, or both, is contemplated. Similarly, the second cooling aperture 140b, similar to that shown in FIG. 2, is arranged relatively nearer to the trailing edge 126 and the tip 106, with an orientation toward where the trailing edge 126 meets the tip 106.

The third cooling aperture 140c is arranged relatively nearer to the leading edge 124 and the root 108. The third cooling aperture 140c is oriented away from where the leading edge 124 meets the root 108, where it is nearest, and is oriented toward where the tip 106 meets the trailing edge 126, similar to that of the second cooling aperture 140b. The fourth cooling aperture 140d is arranged relatively nearer to the trailing edge 126 and the root 108, with an orientation toward the trailing edge 126.

It should be appreciated that any orientation for the cooling aperture 140a-d is contemplated, such as an orientation toward one or more of the tip 106, the root 108, the leading edge 124, and the trailing edge 126. It should be further appreciated that any positioning for the cooling aperture 140a-d is contemplated, such as any position along the outer wall 118, as well as among either or both of the pressure side 120 and the suction side 122, as well as on the platform 110. That is, any orientation for the cooling aperture 140a-d having any position within the outer wall 118 is contemplated. Further orientation relative to the span-wise direction (SPd), the chord-wise direction (CHd), or both is further contemplated.

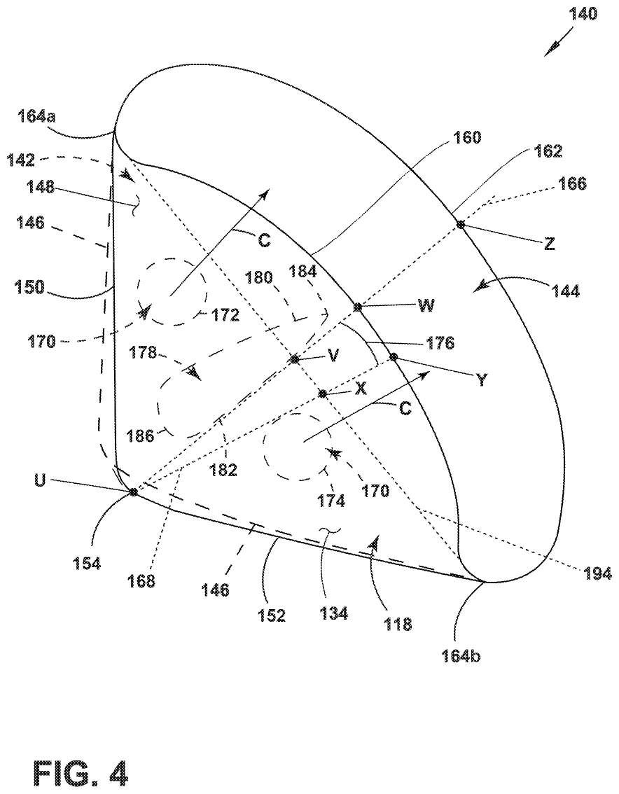

FIG. 4 is an enlarged schematic view of the cooling aperture 140 of FIG. 2, with the cavity 142 positioned within a portion of the outer wall 118. FIG. 4 is a view of the exterior surface 134 where the cooling aperture 140 is located, and the various lines defining the cooling aperture 140 have been superimposed onto a virtual two-dimensional (2D) plane on the exterior surface 134. The cavity 142 is defined between an inner surface 146, outlined in broken line, and an outer surface 148 spaced from the inner surface 146. The inner surface 146 is the surface of the cavity 142 closest to the interior surface (i.e., the interior 130) of the outer wall 118, and the outer surface 148 is the surface of the cavity 142 closest to the exterior surface 134 of the outer wall 118. The inner surface 146 may be considered a cold surface and the outer surface 148 may be considered a hot surface. The inner surface 146 and the outer surface 148 are adjoined at a first side 150 and a second side 152 of the cavity 142. In a non-limiting example, the first side 150 and the second side 152 can be similar in shape and size, having a common length and curvature defined by a common geometry. In another non-limiting example, the first side 150 and the second side 152 can be dissimilar, such as having different shapes or sizes, such as differing lengths, curvatures, linear portions, or geometries. In such an example, the cooling aperture 140 can be non-symmetric. A junction 154 is defined as the point where the first side 150 meets the second side 152, and is midway between the inner surface 146 and the outer surface 148. The junction 154 is projected onto the 2D plane of FIG. 4. The junction 154 defines a rear or apex of the cooling aperture 140, such that the cooling aperture includes a closed end at the junction 154. The cooling aperture 140 can be symmetric about an axis defined extending from the junction 154 equidistant from both the first side 150 and the second side 152, while non-symmetric cooling apertures 140 with similar or common first and second sides edges 150, 152 are contemplated.

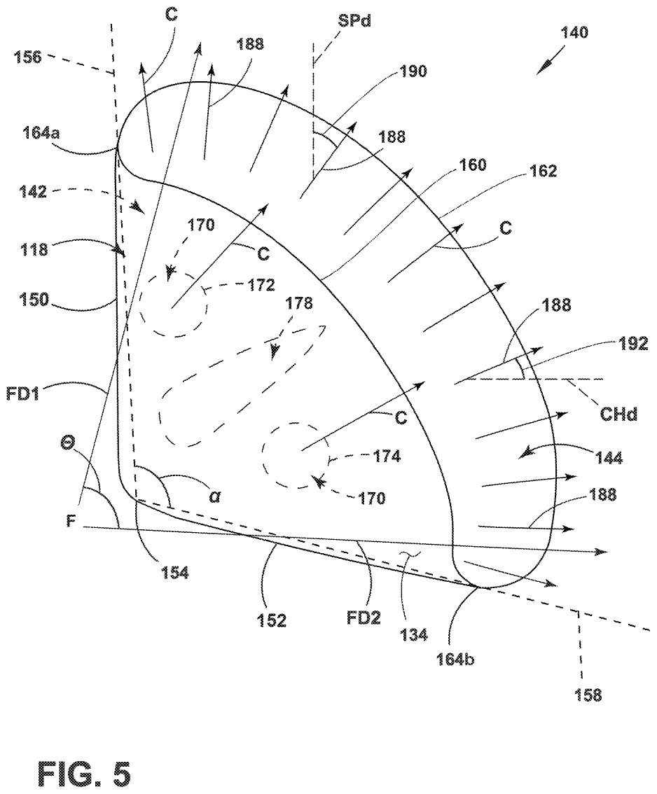

The diffuser outlet 144 is the opening in the exterior surface 134 where the cooling fluid flow (C) from the cavity 142 is exhausted or vented. The diffuser outlet 144 includes an inner edge 160 and an outer edge 162, with the inner edge 160 nearer to the junction 154 than the outer edge 162. The inner edge 160 and the outer edge 162 can be curved. In particular, as shown in FIG. 4, the inner edge 160 and the outer edge 162 have a concave curvature relative to the junction 154. The junction axis 166 can be defined extending from the junction 154 to the outer edge 162 defined equidistant between the first side 150 and the second side 152 and an offset axis 168 can be defined extending from the junction 154 and offset from the junction axis 166 by a non-zero angle 176. The inner edge 160 meets the outer edge 162 at opposing ends 164a, 164b. Referring briefly to FIG. 5, which is the same as FIG. 4 but with additional axes and elements labeled, the first opposing end 164a is a first point on the diffuser outlet 144 where a first axis 156 extending from the junction 154 touches (meets) the outer most end of the diffuser outlet 144, and the second opposing end 164b is a second point on the opposite end of the diffuser outlet 144 where a second axis 158 extending from the junction 154 touches (meets) the other outer most end of the diffuser outlet 144. Referring back to FIG. 4, an end axis 194 is defined extending between the opposing ends 164a, 164b. In one example, the opposing ends 164a, 164b can be formed as curved ends, which are continuous with the curvature of the inner edge 160 or the outer edge 162 but having lesser radiuses of curvature in order to adjoin the inner edge 160 to the outer edge 162. It is also contemplated that the opposing ends 164a, 164b are non-continuous or have additional non-curved geometries in additional non-limiting examples.

A first point U is defined at the junction 154. A second point V is defined where the junction axis 166 intersects the end axis 194. A third point W is defined where the junction axis 166 intersects the inner edge 160. A fourth point X is defined where the offset axis 168 intersects the end axis 194. A fifth point Y is defined where the offset axis 168 intersects the inner edge 160. A sixth point Z is defined where the junction axis 166 intersects the outer edge 162. A distance UZ from the first point U to the sixth point Z is greater than a distance UW from the first point U to the third point W. Furthermore, the cooling aperture 140 is shaped such that the distance UW from the first point U to the third point W is greater than a distance UV from the first point U to the second point V and such that a distance UY from the first point U to the fifth point Y is greater than a distance UX from the first point U to the fourth point X. Due to the concave geometry of the diffuser outlet 144 defined by the inner and outer edges 160, 162, the distances from the first point U at the junction 154 to where the end axis 194 intersects the junction axis 166 and the offset axis 168 are lesser than the distances from the first point U to where the inner edge 160 intersects the junction axis 166 and the offset axis 168. Without such a curved geometry, there would be no distance between the second point V and the third point W, as well as between the fourth point X and the fifth point Y.

The inner and outer edges 160, 162 can be similar, in a non-limiting example, such as having a similar curvature or a similar radius of curvature. It is contemplated that such a similarity can be further defined by a common size factor, relative to the distance from the junction 154, such that the outer edge 162 is relatively larger than the inner edge 160 due to the widening nature of the cooling aperture 140 as it extends from the junction 154. More specifically, the inner edge 160 can have a first length or a first curvature, and the outer edge 162 can have the same length or curvature as the first length or the first curvature, except increased by a factor dependent upon distance from the junction 154. In this way, the cooling aperture 140 can be symmetric at the diffuser outlet 144. In another non-limiting example, the inner edge 160 can be dissimilar from the outer edge 162, such as having a different curvature or a different length. In yet another non-limiting example, the distance between the inner edge 160 and the outer edge 162 can be non-equidistant extending between the opposing ends 164a, 164b. Additionally, it is contemplated that the opposing ends 164a, 164b are similar or dissimilar, with or without consideration of the relationship with or among the inner edge 160 and the outer edge 162.

The cooling aperture 140 includes a pair of metering holes 170, which includes a first metering hole 172 and a second metering hole 174. The pair of metering holes 170 are illustrated in broken line, exhausting at the inner surface 146 such that a cooling fluid flow (C) impinges upon the outer surface 148. In a non-limiting example, it is contemplated that the metering holes 170 can exhaust from the outer surface 148, impinging upon the inner surface 146. While the pair of metering holes 170 are shown, any number of metering holes is contemplated including one or more. The pair of metering holes 170 extend through a portion of the outer wall 118 and fluidly couple the cavity 142 to the at least one cooling circuit 132 (FIG. 2) to permit a volume of cooling fluid flow (C) to flow into the cavity 142 and ultimately exhaust at the diffuser outlet 144. In some examples, the metering holes 170 have a circular cross-section, but in other examples can have other shaped cross-sections (e.g., oval, rectilinear, elliptical, disctorectangular (stadium or racetrack), etc.).

The airfoil 104 includes a pin 178 positioned within the cavity 142, shown in broken line beneath the exterior surface 134, extending between the inner surface 146 and the outer surface 148. The pin 178 includes a first pin side 180 and a second pin side 182 that meet at a pointed end 184, and further includes a wide end 186 spacing the first pin side 180 from the second pin side 182, opposite of the pointed end 184. As such, the pin 178 has a substantially tear drop shape. It should be appreciated that additional cross-sectional shapes for the pin 178 are contemplated, including but not limited to, circular, racetrack, oval, elliptical, rounded, curved, linear, curvilinear, airfoil, or combinations thereof. Furthermore, while only the single pin 178 is shown, any number of pins is contemplated, including, zero, one, or more.

FIG. 5 is the same view as FIG. 4, but with additional element and lines labeled. Referring to FIG. 5, a cavity angle (α) can be defined between the first side 150 and the second side 152. More specifically, a first axis 156 extends from the junction 154 to where the first side 150 meets the diffuser outlet 144 at the first opposing end 164, and a second axis 158 extends from the junction 154 to where the second side 152 meets the diffuser outlet 144 at the second opposing end 164b. The cavity angle (α) is defined as the angle between the first axis 156 and the second axis 158, in the 2D plane represented by FIG. 5. In some examples, the cavity angle (α) can be greater than or equal to 75 degrees (75°) and less than or equal to 135 degrees (135°).

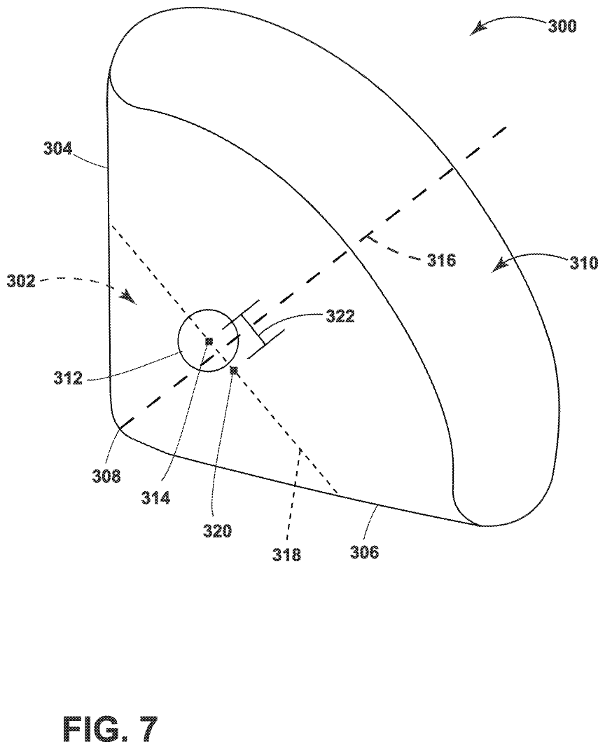

The first metering hole 172 and the second metering hole 174 each have a minimum hydraulic diameter (dₕ). For a cooling aperture 140 having only one metering hole (see FIG. 7, for example), the minimum hydraulic diameter (dₕ) for that cooling aperture 140 is defined as the minimum hydraulic diameter (dₕ) for the single metering hole that supplies the cavity 142 with cooling fluid. Where a cooling aperture 140 includes two or more metering holes, such as the pair of metering holes 170, the minimum hydraulic diameter (dₕ) for the cooling aperture is defined as an average of the minimum hydraulic diameters (dₕ) among the first metering hole 172 and the second metering hole 174 that supply the cavity 142 with cooling fluid. In examples where the cooling aperture 140 has more than two metering holes, the minimum hydraulic diameter (dₕ) of the cooling aperture 140 is the average of all of the minimum hydraulic diameters of the individual metering holes.

In a non-limiting example, the positioning for the cooling aperture 140 can be a function of the minimum hydraulic diameter (dₕ) of the cooling aperture 140 relative to the outlet edge distance (d_{edge}) (FIG. 2). The outlet edge distance (d_{edge}) (FIG. 2) and the minimum hydraulic diameter (dₕ) of the cooling aperture 140 can be defined by the following Expression 1:

$$Expression 1$$

$$0 \leq \frac{{d}_{edge}}{{d}_{h}} \leq 30. \qquad ( 1 )$$

In another non-limiting example, the outlet edge distance (d_{edge}) (FIG. 2) and the minimum hydraulic diameter (dₕ) of the cooling aperture 140 can be defined by the following Expression 2:

$$Expression 2$$

$$0 \leq \frac{{d}_{edge}}{{d}_{h}} \leq 10. \qquad ( 2 )$$

In yet another non-limiting example, the outlet edge distance (d_{edge}) (FIG. 2) and the minimum hydraulic diameter (dₕ) of the cooling aperture 140 can be defined by the following Expression 3:

$$Expression 3$$

$$0 \leq \frac{{d}_{edge}}{{d}_{h}} \leq 5. \qquad ( 3 )$$

In some examples, the minimum hydraulic diameter (dₕ) of the cooling aperture 140 is 0.0254 to 0.07112 centimeters (cm) (i.e., 0.010 to 0.028 inches). In some examples, the outlet edge distance (d_{edge}) is 0 to 2.1336 cm (i.e., 0 to 0.84 inches).

In yet another non-limiting example, the positioning of the cooling aperture 140 on the outer wall 118 can be a function of the minimum hydraulic diameter (dₕ) relative to the film hole radial distance (d_{radial}) (FIG. 2). The minimum hydraulic diameter (dₕ) of the cooling aperture 140 and the film hole radial distance (d_{radial}) (FIG. 2) can be defined by the following Expression 4:

$$Expression 4$$

$$0 \leq \frac{{d}_{radial}}{{d}_{h}} \leq 30. \qquad ( 4 )$$

In some examples, the minimum hydraulic diameter (dₕ) of the cooling aperture 140 is 0.0254 to 0.07112 centimeters (cm) (i.e., 0.010 to 0.028 inches), and the film hole radial distance (d_{radial}) is 0 to 2.1336 cm (i.e., 0 to 0.84 inches).

During operation of the gas turbine engine 10 (FIG. 1), a flow of hot fluid (F), such as hot combustion gasses from the combustion section 28 (FIG. 1), passes over the exterior surface 134 of the outer wall 118. The flow of hot fluid (F) can have varying flow components in varying directions along the exterior surface 134, illustrated as moving in a first flow direction (FD1) and a second flow direction (FD2). Variation among the direction of flow components can be defined as an angle (Θ). In a non-limiting example, the angle (Θ) can be greater than 10 degrees (10°). In another non-limiting example, the angle (Θ) can be greater than twenty-five degrees (25°).

In operation, a volume of the cooling fluid flow (C) is provided to the cavity 142 from the pair of metering holes 170. The cooling fluid flow (C) spreads within the cavity 142, where it can cool adjacent areas of the outer wall 118, including the inner surface 146 (FIG. 3), the outer surface 148, the first side 150, the second side 152, and any portion of the outer wall 118 defining the cavity 142 and the diffuser outlet 144. The particular directionalities for the spread of the cooling fluid flow (C) within the cavity 142 are dependent on the location, number, and geometry for the pair of metering holes 170 and the pin 178, as well as the particular arrangement and geometry for the cavity 142 as defined by the inner surface 146, the outer surface 148, the outer wall 118, the first side 150, the second side 152, and the diffuser outlet 144.

The cooling fluid flow (C) exhausts from the diffuser outlet 144 to define a set of flow components illustrated as flow components 188, which can spread along the exterior surface 134 of the outer wall 118, downstream of the diffuser outlet 144, as a cooling film along the exterior surface 134 of the outer wall 118. Diffusion of the cooling fluid flow (C), flow components 188 thereof, or local directionalities thereof, can be defined by arrangement or geometry of the pair of metering holes 170, the pin 178, the diffuser outlet 144, or features defining the cavity 142 such as the inner surface 146, the outer surface 148, the outer wall 118, the first side 150, and the second side 152. Additionally, the flow rate for the cooling fluid flow (C) exhausting from the diffuser outlet 144 can be a function of flow rate or pressure of the cooling fluid flow (C) within the cavity 142. Each of the flow components 188 can have an angular orientation, being arranged at a span-wise flow component angle 190 defined relative to the span-wise direction (SPd), and/or a chord-wise flow component angle 192 defined relative to the chord-wise direction (CHd). In a non-limiting example, the span-wise flow component angle 190 for the flow components 188 for the cooling fluid flow (C) can differ by at least thirty degrees (30°) at the diffuser outlet 144, relative to a common direction, such as either of the span-wise direction (SPd) or the chord-wise direction (CHd). In another non-limiting example, the span-wise flow component angle 190 for the flow components 188 can be greater than or equal to −90 degrees (−90°) and less than or equal to 90 degrees (90°), relative to a common direction. Such a difference in flow components 188 results in improved cooling film performance, as opposed to a standard cooling hole, as the wider range of angles for the flow components 188 has improved film effectiveness against a wide range of flow directions, such as the first and second flow directions (FD1), (FD2), or among the angle (Θ) defined therebetween.

The cooling aperture 140 as described herein provides for improved local cooling by greater heat transfer along portions of the airfoil 104 (FIG. 2) or component with the cooling aperture 140. Cooling of areas along the tip 106 (FIG. 2) and trailing edge 126 (FIG. 2) can be particularly difficult, in addition to bridging cooling film gaps among nearby film holes in those areas. Such a difficulty is the result of relatively higher variability in flow components due to the vortex generated at the tip 106. Additionally, the airfoil 104 (FIG. 2) typically thins nearer to the trailing edge 126, reducing usable cooling volume, space, or area of the airfoil 104 (FIG. 2). Such limited space is further limited by tip plenums provided at the tip 106 (FIG. 2), making areas near both the trailing edge 126 (FIG. 2) and the tip 106 (FIG. 2) particularly difficult to effectively cool. Furthermore, manufacture of tip holes for cooling at the tip or trailing edge are difficult to produce at high yields. Using the cooling aperture 140 can reduce or eliminate the requirement for local tip holes, which can increase manufacture yield. Additionally, the relatively larger cooling aperture 140 (as compared to traditional film holes) can have less debris build-up, such as dust accumulation, which can minimize or reduce the instance of local heat increases or required cleaning and maintenance.

The cooling aperture 140 and the at least 30-degree variance among the flow components 188 of the cooling fluid flow (C) exhausting from the diffuser outlet 144 provides for a wide breadth of cooling film provided along the outer wall 118. That is, the arrangement of the cooling aperture 140 and the at least 30-degree variance among the flow components 188 provide a wider breadth than traditional film holes or other cooling features that cannot provide at least a 30-degree variance in flow components 188. In other words, existing cooling holes/features produce targeted or narrow flow components, whereas the example cooling aperture 140 allows for more angled cooling flow, resulting in a wider breadth of cooling film. Such a wide breadth of cooling film provided by the cooling aperture 140 can be particularly beneficial in the difficult areas along the tip 106 (FIG. 2) and the trailing edges 126 (FIG. 2). In components, generally, the wide breadth of cooling film is beneficial for cooling areas of the component near or adjacent the edges, where flow exterior flow components tend to vary the greatest. Furthermore, the positioning functions defined by Expressions 1-3 provide for arranging the cooling aperture 140 relative to the nearest edge (i.e., tip 106, root 108, leading edge 124, trailing edge 126) in order to provide effective local cooling and effective film cooling with respect to that nearest edge. The positioning function defined by Expression 4 provides for arranging the cooling aperture 140 relative to the nearest film hole 136 (FIG. 2) or row of film holes 138 (FIG. 2) in order to provide effective local cooling or film coverage with respect to nearby film holes.

The cooling aperture 140 provides a shape that yields higher local cooling performance with greater film coverage area as compared to traditional cooling methods and holes. The particular shape leverages additive manufacturing techniques to permit unconventional shapes previously not possible with traditional manufacture methods like drilling and casting. Additionally, the shape of the cooling aperture 140 can increase manufacturability, as the cooling aperture's shape increases ligament area in the print plane, which is typically parallel to or almost parallel to the platform 110 (FIG. 2). Additionally, the cooling aperture 140 can be produced with advanced manufacturing methods, such as methods that produce refractory metal cores containing the cooling aperture 140, where the cooling hole shape is formed of refractory metal via sheet metal, additive manufacturing, or other methodologies.

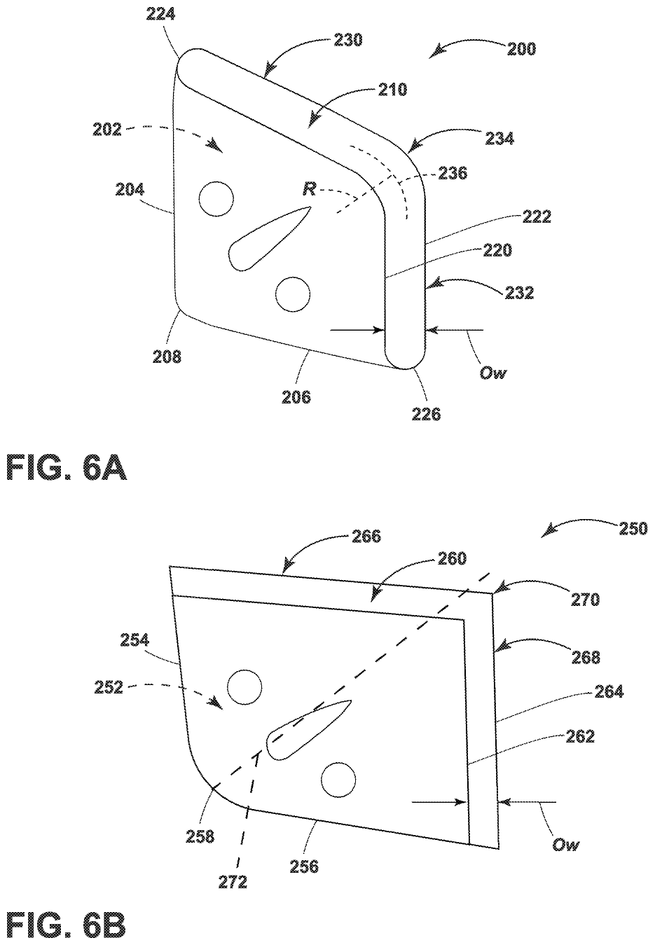

In some examples, the diffuser outlet may not have a continuous curvature between the two opposing ends. For example, referring to FIG. 6A, a cooling aperture 200 has a cavity 202 defined between a first side 204 and a second side 206 that meet at a junction 208. The cavity 202 exhausts at a diffuser outlet 210 extending between the first side 204 and the second side 206. Similar to FIGS. 4 and 5, FIG. 6A is a schematic view of the cooling aperture 200 from the exterior surface 134 (FIG. 2) as projected onto a 2D plane of the exterior surface 134.

The diffuser outlet 210 includes an inner edge 220 and an outer edge 222, which extend between a first opposing end 224 adjacent the first side 204 and a second opposing end 226 adjacent the second side 206. The diffuser outlet 210 includes a first linear portion 230 arranged at the first opposing end 224 and a second linear portion 232 arranged at the second opposing end 226, with a curved portion 234 extending between the first linear portion 230 and the second linear portion 232. An outlet width (Ow) can be defined as the distance between the inner edge 220 and the outer edge 222 and can be consistent along the entirety of the diffuser outlet 210, excepting the curvature at the first opposing end 224 and the second opposing end 226. In one non-limiting example, the outlet width (Ow) can be measured perpendicular to the inner edge 220, the outer edge 222, or both. The curved portion 234 can define a curved axis 236 equidistant between the inner edge 220 and the outer edge 222, with the curved axis 236 defining a radius of curvature (R). In some examples, a ratio of the radius of curvature (R) to the outlet width (Ow) is from 3 to

$$10 ( i . e . , 3 \leq \frac{R}{Ow} \leq 10 ) .$$

Referring to FIG. 6B, a cooling aperture 250 has a cavity 252 defined between a first side 254 and a second side 256 that meet at a junction 258. The cavity 252 exhausts at a diffuser outlet 260 extending between the first side 254 and the second side 256.

The diffuser outlet 260 includes inner edge 262 and an outer edge 264, defining an outlet width (Ow) therebetween. The diffuser outlet 260 further includes a first linear portion 266 that meets a second linear portion 268 at a point 270. In another non-limiting example, the outlet width (Ow) can be measured as the distance between the inner edge 262 and the outer edge 264 determined along a junction axis 272 extending from the junction 258 and equidistant between the first side 254 and the second side 256.

Referring to FIG. 7, a cooling aperture 300 has a cavity 302 defined between a first side 304 and a second side 306 that meet at a junction 308. The cavity 302 exhausts at a diffuser outlet 310 extending between the first side 304 and the second side 306. Similar FIGS. 4 and 5, FIG. 7 is a schematic view of the cooling aperture 300 from the exterior surface 134 (FIG. 2) as projected onto a 2D plane of the exterior surface 134.

The cooling aperture 300 has a metering hole 312, with a center point 314, that fluidly couples to the cavity 302. The metering hole 312 can define a minimum hydraulic diameter (dₕ). A junction axis 316 can be defined extending from the junction 308 and equidistant between the first side 304 and the second side 306. A perpendicular axis 318 can be defined perpendicular to the junction axis 316 at any position along the junction axis 316, with the perpendicular axis 318 extending between the first side 304 and the second side 306. A midpoint 320 for the perpendicular axis 318 can be defined as the midpoint equidistant between the first side 304 and the second side 306.

In an example, the center point 314 for the metering hole 312 is located within a metering hole distance 322 of the midpoint 320. That is, the metering hole 312 can be located within the metering hole distance 322 for a midpoint 320 defined for any perpendicular axis 318 extending along any position of the junction axis 316. In an example, the metering hole distance 322 positioning the metering hole 312 is less than or equal to five minimum hydraulic diameters (dₕ). In another example, the metering hole distance 322 is less than or equal to one minimum hydraulic diameter (dₕ).

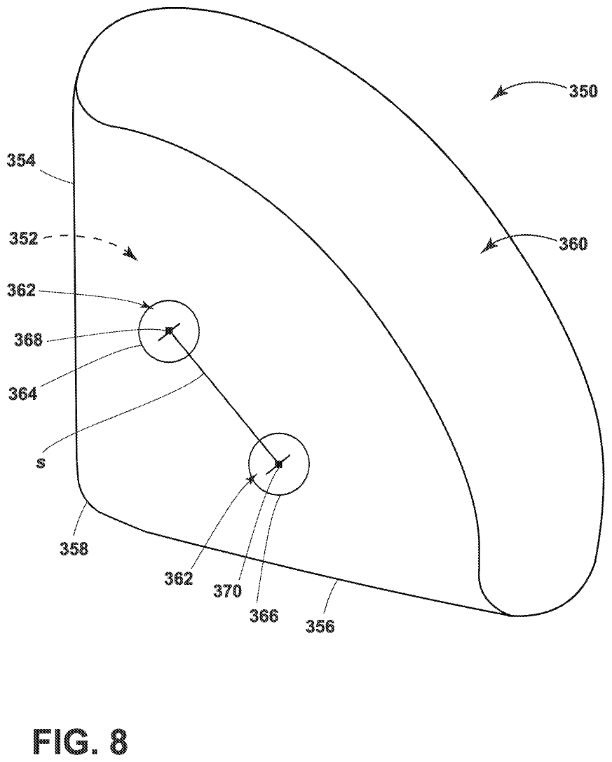

Referring to FIG. 8, a cooling aperture 350 has a cavity 352 defined between a first side 354 and a second side 356 that meet at a junction 358. The cavity 352 exhausts at a diffuser outlet 360 extending between the first side 354 and the second side 356. Similar FIGS. 4 and 5, FIG. 8 is a schematic view of the cooling aperture 350 from the exterior surface 134 (FIG. 2) as projected onto a 2D plane on the exterior surface 134. In this example, the cooling aperture 350 includes a pair of metering holes 362 that fluidly couple to the cavity 352. The pair of metering holes 362 includes a first metering hole 364 having a first center point 368 and a second metering hole 366 having a second center point 370.

The first metering hole 364 is spaced from the second metering hole 366 by a spacing distance(s). The spacing distance(s) is defined as the distance between the first center point 368 of the first metering hole 364 and the second center point 370 of the second metering hole 366. Where more than two metering holes are utilized, the spacing distance(s) can be defined as the distance between center points for the two nearest metering holes. Each of the first metering hole 364 and the second metering hole 366 can define a minimum hydraulic diameter (dₕ). The minimum hydraulic diameter (dₕ) for the cooling aperture 350 is an average of the minimum hydraulic diameters (dₕ) of the first metering hole 364 and the second metering hole 366.

In a non-limiting example, the minimum hydraulic diameter (dₕ) of the cooling aperture 350 can be a function of the spacing distance(s). The minimum hydraulic diameter (dₕ) of the cooling aperture 350 and the spacing distance(s) can be defined by the following Expression 5:

$$Expression 5$$

$$0.10 \leq \frac{{d}_{h}}{s} \leq 0.70 . \qquad ( 5 )$$

In another non-limiting example, the minimum hydraulic diameter (dₕ) of the cooling aperture 350 and the spacing distance(s) can be defined by the following Expression 6:

$$Expression 6$$

$$0.20 \leq \frac{{d}_{h}}{s} \leq 0.50 . \qquad ( 6 )$$

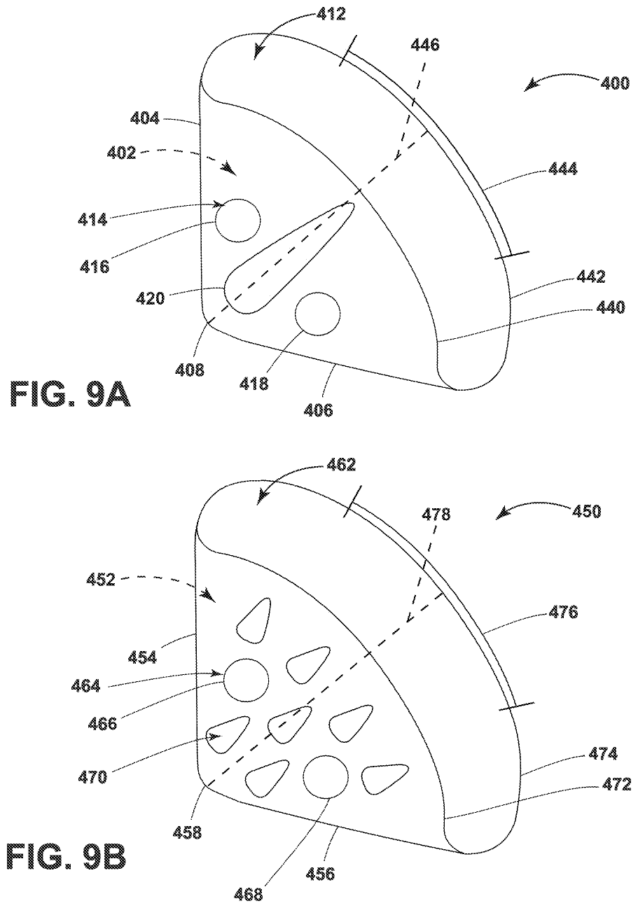

Referring now to FIG. 9A, a cooling aperture 400 has a cavity 402 defined between a first side 404 and a second side 406 that meet at a junction 408. The cavity 402 exhausts at a diffuser outlet 412 extending between the first side 404 and the second side 406. Similar FIGS. 4 and 5, FIG. 9A is a schematic view of the cooling aperture 400 from the exterior surface 134 (FIG. 2) as projected onto a 2D plane on the exterior surface 134. The cooling aperture 400 includes at least one metering hole 414, such as a first metering hole 416 and a second metering hole 418. A pin 420 is positioned within the cavity 402 and can be further positioned between the first metering hole 416 and the second metering hole 418.

The diffuser outlet 412 includes an inner edge 440 spaced from an outer edge 442. An inner section 444 of the outer edge 442 can be defined by the inner 50% of the outer edge 442. More specifically, where 100% represents the full length of the outer edge 442, then the inner 50% of the inner section 444 can be spaced by 25% of the length of the outer edge 442 on both sides of the inner section 444.

A junction axis 446 is defined extending from the junction 408 to the outer edge 442 at any portion of the inner section 444. A length for the junction axis 446 can be defined as the distance between the junction 408 and any position on the outer edge 442 within the inner section 444. The position, size, and geometry for the pin 420 can be defined such that at least one junction axis 446 defined extending to any portion of the inner section 444 is occupied by the pin 420 for greater than or equal to 30% or less than or equal to 70% of the length of the junction axis 446. This range ensures producibility (e.g., during manufacturing) as well as ensures enough flow can fill the diffuser outlet 412.

Referring to FIG. 9B, a cooling aperture 450 has a cavity 452 defined between a first side 454 and a second side 456 that meet at a junction 458. The cavity 452 exhausts at a diffuser outlet 462 extending between the first side 454 and the second side 456. The cooling aperture 405 includes at least one metering hole 464, such as a first metering hole 466 and a second metering hole 468. A set of multiple pins 470 are arranged within the cavity 452.

The diffuser outlet 462 includes an inner edge 472 spaced from an outer edge 474. An inner section 476 of the outer edge 474 can be defined by the inner 50% of the outer edge 474. More specifically, where 100% represents the full length of the outer edge 474, then the inner 50% defining the inner section 476 can be spaced by 25% of the length of the outer edge 474 on both sides of the inner section 476.

A junction axis 478 can be defined extending from the junction 458 to any position of the inner section 476. The position, size, and geometry for the set of multiple pins 470 can be defined such that at least one junction axis 478 extending to any portion of the inner section 476 is occupied by one or more pins of the set of multiple pins 470 for greater than or equal to 30% or less than or equal to 70% of the length of the junction axis 478.

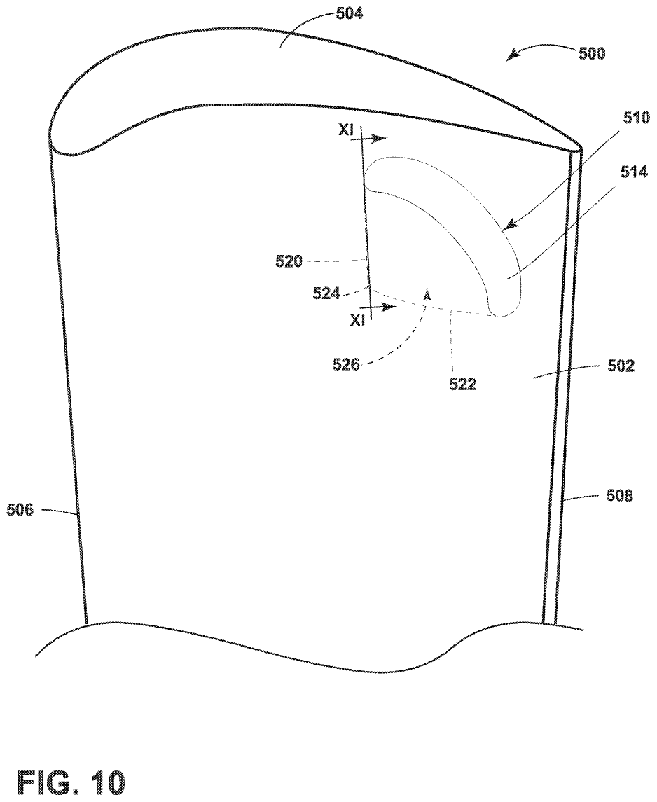

FIG. 10 shows an airfoil 500 with an outer wall 502 including a tip 504 extending between a leading edge 506 and a trailing edge 508. A cooling aperture 510 includes a cavity 526 positioned within the outer wall 502 and exhausting at a diffuser outlet 514. The cooling aperture 510 includes a first side 520 meeting a second side 522 at a junction 524, with each of the first side 520 and the second side 522 extending from the junction 524 to the diffuser outlet 514. Section XI-XI is taken along the first side 520, through the outer wall 502, looking toward the trailing edge 506 at the tip 504.

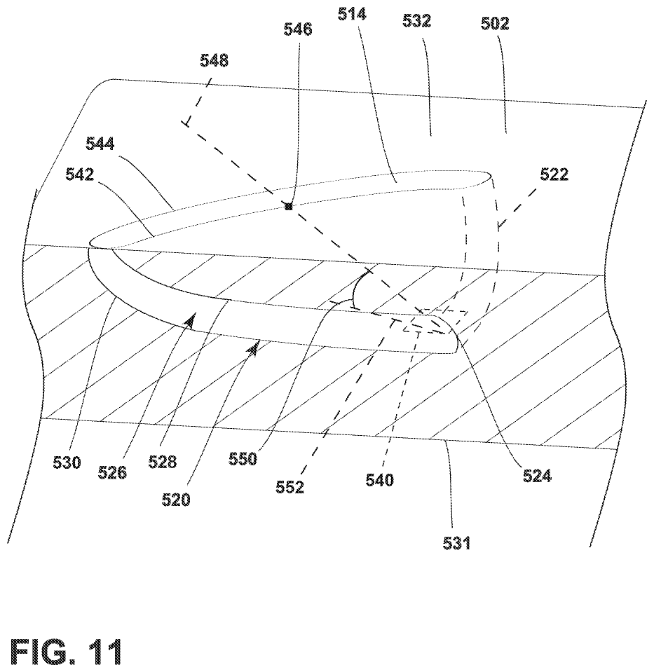

FIG. 11 shows a cross-sectional view of the outer wall 502 taken along section XI-XI of FIG. 10. The outer wall 502 has an interior surface 531, which faces the interior cooling conduit(s), and an exterior surface 532, opposite the interior surface 531, which is exposed to the hot combustion gases in the engine. The cavity 526 is at least partially defined between an outer surface 528 and an inner surface 530, which extend between and meet at the first side 520 and the second side 522 and terminate at the diffuser outlet 514.

The first side 520 and the second side 522 can be at least partially curved, curving in a direction toward a hot surface as the exterior surface 532 of the outer wall 502 from within the outer wall 502. The first and second sides 520, 522 are positioned within the outer wall 502 and meet at a junction 524, which is a point midway between the outer surface 528 and the inner surface 530. The first and second sides 520, 522 curve to meet the exterior surface 532 at the diffuser outlet 514. The outer surface 528 and the inner surface 530 curve with the first side 520 and the second side 522, at least partially defining the curved geometry for the cavity 526.

A virtual plane 540 can be defined within the cavity 526, extending from the junction 524, and spaced equidistant from the inner surface 530 and the outer surface 528. The geometry of the cooling aperture 510 can be such that at least a portion of the cavity 526 is defined between parallel and planar portions of the inner surface 530 and the outer surface 528. That is, at least a portion of the cavity 526 is defined between planar portions of the inner surface 530 and the outer surface 528, which are arranged parallel to one another. The virtual plane 540 is defined as a plane equidistant from the parallel and planar portions of the inner surface 530 and the outer surface 528, extending from the junction 524.

The diffuser outlet 514 includes an inner edge 542 and an outer edge 544. A midpoint 546 for the inner edge 542 is defined equidistant from the first side 520 and the second side 522 along the length of the inner edge 542. A midpoint axis 548 can be defined as extending between the junction 524 and the midpoint 546.

A curvature angle 550 can be defined between the midpoint axis 548 and the virtual plane 540. More specifically, the curvature angle 550 can be measured between the midpoint axis 548 and the nearest line arranged along the virtual plane 540, defined relative to the midpoint axis 548, or stated another way, can be defined as the angle between the midpoint axis 548 and a projection 552 of the midpoint axis 548 onto the virtual plane 540. The curvature of the first side 520 and the second side 522 can have a shape or geometry such that the curvature angle 550 is greater than or equal to 1 degree (1°) and less than or equal to 10 degrees (10°), in a non-limiting example.

In this way, it should be appreciated that the cooling aperture 510 is curved. More specifically, the cooling aperture 510 can at least partially curve such that one or both of the inner surface 530 and the outer surface 528 curve toward the exterior surface 532, such that at least a portion of the cavity 526 is non-flat or non-planar.

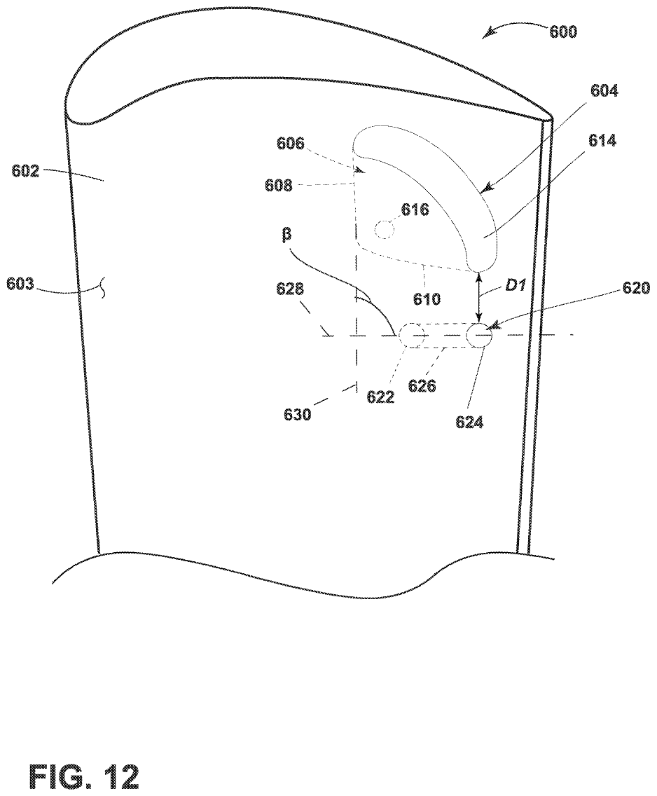

Referring to FIG. 12, a component provided as an airfoil 600 has an outer wall 602 with a cooling aperture 604. The outer wall 602 has an exterior surface 603. The cooling aperture 604 defines a cavity 606 within the outer wall 602 extending between a first side 608 and a second side 610. The cavity 606 exhausts at a diffuser outlet 614 extending between the first side 608 and the second side 610. At least one metering hole 616 fluidly couples to the cavity 606. The metering hole 616 defines a minimum hydraulic diameter (dₕ) for the cooling aperture 604.

The airfoil 600 has a cooling hole 620 (which may also be referred to as a film hole) in the outer wall 602 having an inlet 622 and an outlet 624, defining a cooling hole passage 626 therebetween. A cooling hole axis 628 can be defined as the longitudinal axis extending between the inlet 622 and the outlet 624 and projected onto the 2D plane of the exterior surface 603. While only a single cooling hole 620 is illustrated, any number of cooling holes are contemplated, including a set of cooling holes or a row of cooling holes. Furthermore, any shape or geometry is contemplated for the cooling hole 620.

An adjacent cooling hole distance (D1) can be defined as the minimum distance between the diffuser outlet 614 and the outlet 624 of the cooling hole 620. Where multiple cooling holes are utilized, the adjacent cooling hole distance (D1) can be defined by the nearest cooling hole to the cooling aperture 604, or by the outlet for the multiple cooling holes nearest to the diffuser outlet 614. An axis can be defined along either of the first side 608 or the second side 610 furthest from the cooling hole 620. That is, a first side axis 630, as projected onto the exterior surface 603, can be defined extending along the first side 608 as the first side 608 is further from the cooling hole 620 than the second side 610. An adjacent cooling hole angle (B) can be defined as the angle between the first side axis 640 and the cooling hole axis 628. In a non-limiting example, the adjacent cooling hole angle (B) can be less than 110 degrees (110°). In additional non-limiting examples, the adjacent cooling hole angle (β) can be less than 90 degrees (90°), less than 70 degrees (70°), less than 45 degrees (45°), or less than 30 degrees (30°).

In a non-limiting example, the adjacent cooling hole distance (D1) can be a function of the minimum hydraulic diameter (dₕ) of the cooling aperture 604. The adjacent cooling hole distance (D1) and the minimum hydraulic diameter (dₕ) of the cooling aperture 604 can be defined by the following Expression 7:

$$Expression 7$$

$$\frac{D 1}{{d}_{h}} < 30 . \qquad ( 7 )$$

In another non-limiting example, the adjacent cooling hole distance (D1) and the minimum hydraulic diameter (dₕ) of the cooling aperture 604 can be defined by the following Expression 8:

$$Expression 8$$

$$\frac{D 1}{{d}_{h}} < 10. \qquad ( 8 )$$

In some examples, the minimum hydraulic diameter (dₕ) of the cooling aperture 140 is 0.0254 to 0.07112 centimeters (cm) (i.e., 0.010 to 0.028 inches), and the adjacent cooling hole distance (D1) is less than 2.1336 cm (i.e., 0.84 inches).

The cooling aperture 604 can be utilized to bridge the gap between cooling holes or rows of cooling holes within the airfoil 600, such as the cooling hole 620. In particular, where the cooling holes or rows of cooling holes are oriented at different directions within different portions of the airfoil 600, the cooling aperture 604 provides for bridging the gap between these cooling holes or rows of cooling holes. The particular geometry for the cooling aperture 604 is beneficial for bridging these gaps. Such bridging of the gaps can improve local heat transfer and film cooling along portions of the airfoil 600 that would otherwise be susceptible to increased local heat concentrations, stresses, or lack of film cooling without the cooling aperture 604.

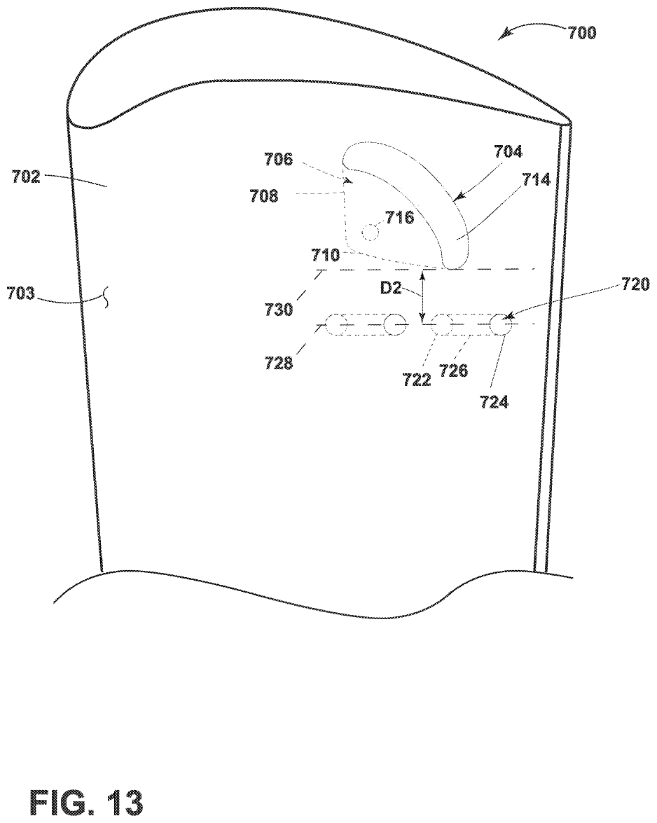

Referring to FIG. 13, a component provided as an airfoil 700 has an outer wall 702 with a cooling aperture 704. The outer wall 702 has an exterior surface 703. The cooling aperture 704 defines a cavity 706 within the outer wall 702 extending between a first side 708 and a second side 710. The cavity 706 exhausts at a diffuser outlet 714. At least one metering hole 716 fluidly couples to the cavity 706. The metering hole 716 can define a minimum hydraulic diameter (dₕ).

A row of cooling holes 720 (which may also be referred to as film holes) is positioned within the outer wall 702, each having an inlet 722 and an outlet 724, defining a cooling hole passage 726 therebetween. While the row of cooling holes 720 are shown extending in the chord-wise direction, any arrangement or orientation of the row of cooling holes 720 is contemplated, such as the radial direction or span-wise direction in non-limiting examples. A cooling hole axis 728 can be defined as the longitudinal axis extending along the row of cooling holes 720 and projected onto the exterior surface 703. Any shape or geometry is contemplated for each cooling hole of the row of cooling holes 720.

A projected axis 730 can be provided along the diffuser outlet 714 arranged parallel to the cooling hole axis 728. The projected axis 730 can position along the diffuser outlet 714 at a position nearest to the row of cooling holes 720. A cooling hole distance (D2) can be defined as the distance between the cooling holes axis 728 and the projected axis 730.

In a non-limiting example, the cooling hole distance (D2) can be a function of the minimum hydraulic diameter (dₕ) of the cooling aperture 704. The cooling hole distance (D2) and the minimum hydraulic diameter (dₕ) of the cooling aperture 704 can be defined by the following Expression 9:

$$Expression 9$$

$$\frac{D 2}{{d}_{h}} < 20 . \qquad ( 9 )$$

In another non-limiting example, the cooling hole distance (D2) and the minimum hydraulic diameter (dₕ) of the cooling aperture 704 can be defined by the following Expression 10:

$$Expression 10$$

$$\frac{D 2}{{d}_{h}} < 10. \qquad ( 10 )$$

In some examples, the minimum hydraulic diameter (dₕ) of the cooling aperture 140 is 0.0254 to 0.07112 centimeters (cm) (i.e., 0.010 to 0.028 inches), and the adjacent cooling hole distance (D1) is less than 1.4224 cm (i.e., 0.56 inches).

The cooling aperture 704 can be utilized to bridge the gap between the rows of cooling holes 720. In particular, where the rows of cooling holes 720 are oriented at different directions within different portions of the airfoil 700, the cooling aperture 704 provides for bridging the gap between the rows of cooling holes 720. The particular geometry for the cooling aperture 704 is beneficial for bridging these gaps. Such bridging of the gaps can improve local heat transfer and film cooling along portions of the airfoil 700 that would otherwise be susceptible to increased local heat concentrations, stresses, or lack of film cooling without the cooling aperture 704.

It will be appreciated that the number, size, and configuration of the cooling apertures are provided by way of example only and that in other exemplary embodiments, the cooling apertures may have any other suitable configuration. The aspects and features provided herein need not be limited to the embodiments as shown, and it is further contemplated that features and aspects from one or more embodiments can be added, removed, or interchanged with one or more other embodiment to define additional embodiments herein.

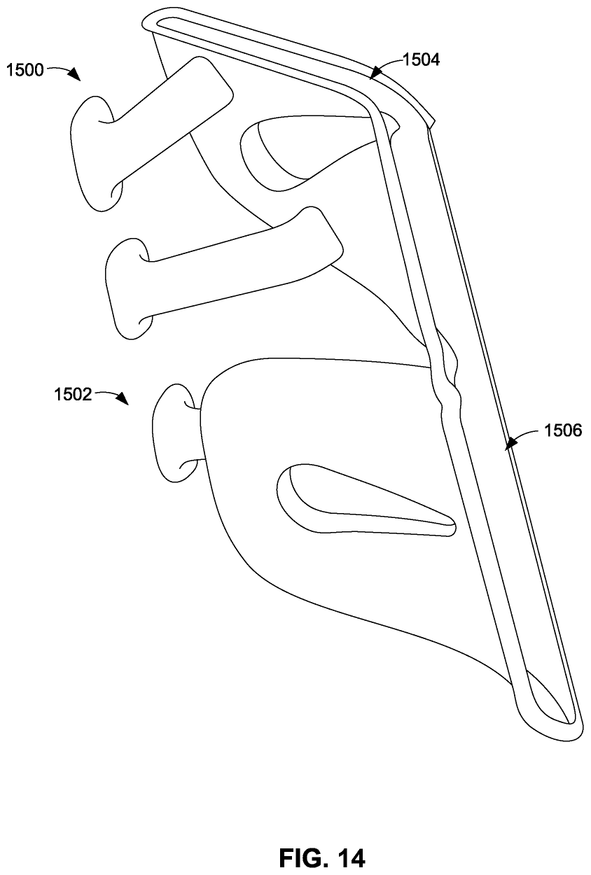

In some examples, two or more cooling apertures can be arranged such their diffuser outlets are combined. For example, FIG. 14 illustrates two example cooling apertures 1500, 1502. The apertures 1500, 1502 are shown in solid lines, but it is understood they represent a cavity or void in the material of the airfoil. The first cooling aperture 1500 has a curved diffuser outlet 1504 (any may be implemented by any of the example cooling apertures disclosed above), whereas the second cooling aperture 1502 has a relatively straight diffuser outlet 1506. The second cooling aperture 1502 can be part of a row of film holes. As shown, the diffuser outlets 1504, 1506 are blended or at least partially connected. Therefore, the diffuser outlets 1504, 1506 can form a continuous opening or outlet in the exterior surface of the airfoil.

Benefits associated with the cooling apertures described herein include improved local cooling and heat transfer of the component or airfoil, as well as improved film cooling of the component or airfoil downstream of the cooling aperture. The geometric envelope for determining the cooling aperture 140, 200, 250, 300, 350, 400, 450, 510, 604, 1500, 1502, its position, or its particular features (i.e., metering holes 170, 172, 174, 312, 362, 364, 366, 414, 416, 418, 464, 466, 468, and pins 178, 420, 470), or its structure (i.e., first side 150, 204, 254, 304, 354, 404, 454, 520, second side 152, 206, 254, 306, 356, 406, 456, 522, junction 154, 208, 258, 308, 358, 408, 458, 524, cavity 142, 202, 252, 302, 352, 402, 452, 526, diffuser outlet 144, 210, 260, 310, 360, 412, 462, 514, etc.) are determined by the airfoil being manufactured, the location of the airfoil in the engine, the materials used, the position of the cooling aperture, or any other design constraint. Narrowing these multiple factors to a region of possibilities saves time, money, and resources, as well as producing a superior performing airfoil having superior cooling and cooling film distribution.

The example cooling apertures disclosed herein are described in connection with an airfoil of a turbine blade assembly. However, any of the example cooling apertures disclosed herein can be similarly implemented in connection with other parts of a turbine blade assembly, such as on an interior wall or rib, a tip wall, on a platform of a turbine blade assembly. For instance, the platform may have one or more internal cooling cavities that receive cooling fluid, and one or more cooling apertures can be provided on the upper or lower surface of the platform to exhaust the cooling fluid to the exterior surface of the platform. Further, any of the example cooling apertures can be implemented on other types of components of a gas turbine engine that require or utilize cooling architecture, such as a fan blade (e.g., fan blade 42 of FIG. 1), a compressor blade (e.g., compressor blade 56, 58 of FIG. 1), a stationary vane (e.g., vane 60, 62, 72, 74 of FIG. 1), a strut, a shroud, a service tube, or a combustion liner wall.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A turbine blade assembly for a gas turbine engine, the turbine blade assembly comprising: an airfoil having an outer wall defining an interior, the outer wall having an interior surface facing the interior and an exterior surface opposite the interior surface; a cooling circuit in the interior to provide a flow of cooling fluid; and a cooling aperture in the outer wall and fluidly coupled to the cooling circuit, the cooling aperture comprising: a cavity in the outer wall, the cavity formed at least partially between a first side and a second side that meet at a junction; at least one metering hole in the outer wall that fluidly couples the cooling circuit and the cavity; and a diffuser outlet exhausting from the cavity at the exterior surface, the diffuser outlet having an inner edge meeting an outer edge at opposing ends at the first side and the second side; wherein a distance between the first side and the second side increases in a direction extending from the junction to the diffuser outlet; and wherein the inner edge and the outer edge have a concave curvature relative to the junction.

The turbine blade assembly of any preceding clause, wherein the at least one metering hole defines a minimum hydraulic diameter (dₕ) of the cooling aperture; wherein an outlet edge distance (d_{edge}) defined as a minimum distance between the diffuser outlet and a nearest edge of the exterior surface; and wherein the outlet edge distance (d_{edge}) and the minimum hydraulic diameter (dₕ) of the cooling aperture are defined by the following expression:

$$0 \leq \frac{{d}_{edge}}{{d}_{h}} \leq 30 .$$

The turbine blade assembly of any preceding clause, wherein the cooling aperture further includes a closed end at the junction.

The turbine blade assembly of any preceding clause, further comprising at least one film hole in the outer wall; wherein the at least one metering hole defines a minimum hydraulic diameter (dₕ) for the cooling aperture; wherein the cooling aperture is spaced from the at least one film hole by a film hole radial distance (d_{radial}) defined as a minimum distance between the at least one film hole and the diffuser outlet; and wherein the film hole radial distance (d_{radial}) and the minimum hydraulic diameter (dₕ) of the cooling aperture are defined by the following expression:

$$0 \leq \frac{{d}_{radial}}{{d}_{h}} \leq 30 .$$

The turbine blade assembly of any preceding clause, further comprising at least one pin in the cavity; wherein the outer edge comprises an inner section defined by the inner 50% of a length of the outer edge, being spaced from each of the opposing ends by 25% of the length of the outer edge; wherein a junction axis is defined extending from the junction to any portion of the inner section and projected onto a two-dimensional plane of the exterior surface; and wherein the at least one pin occupies greater than or equal to 30% and less than or equal to 70% of a length of the junction axis defined extending from the junction to at least one position along the length of the inner section and projected onto the two-dimensional plane.

The turbine blade assembly of any preceding clause, wherein the first side meets the diffuser outlet at a first opposing end and the second side meets the diffuser outlet at a second opposing end; wherein a first axis is defined extending from the junction to a first point at which the first side meets the diffuser outlet at the first opposing end and projected onto a two-dimensional plane of the exterior surface; wherein a second axis is defined extending from the junction to a second point at which the second side meets the diffuser outlet at the second opposing end and projected onto the two-dimensional plane; and wherein a cavity angle (α) is defined as an angle between the first axis and the second axis, and wherein the cavity angle (α) is greater than or equal to 75° and less than or equal to 135°.

The turbine blade assembly of any preceding clause, wherein the diffuser outlet defines an outlet width (Ow); wherein the diffuser outlet includes a first linear portion extending from a first opposing end and a second linear portion extending from a second opposing end, with a curved portion extending between the first linear portion to the second linear portion; wherein a radius of curvature (R) is defined as a radius of a curvature defined equidistant between the inner edge and the outer edge for the curved portion; and wherein the radius of curvature (R) and the outlet width (Ow) are defined by the following expression:

$$3 \leq \frac{R}{Ow} \leq 10 .$$

The turbine blade assembly of any preceding clause, wherein the inner edge defines a midpoint, and defines a midpoint axis extending from the junction to the midpoint; wherein the cavity is further defined between an inner surface spaced from an outer surface in the outer wall; wherein at least a portion of the inner surface and a portion of the outer surface are planar and arranged parallel to one another, defining a virtual plane equidistant from the portion of the inner surface and the portion of the outer surface that are planar and arranged parallel to one another; and wherein a curvature angle is defined between the midpoint axis and a projection of the midpoint axis along the virtual plane, where the curvature angle is greater than or equal to 1° and less than or equal to 10°.

The turbine blade assembly of any preceding clause, further comprising a cooling hole in the outer wall, the cooling hole spaced from the cooling aperture, the cooling hole having an inlet, an outlet, and defining a cooling hole axis.

The turbine blade assembly of any preceding clause, the at least one metering hole defines a minimum hydraulic diameter (dₕ) for the cooling aperture; wherein an adjacent cooling hole distance (D1) is defined as a minimum distance between the diffuser outlet and the outlet for the cooling hole; and wherein the adjacent cooling hole distance (D1) and the minimum hydraulic diameter (dₕ) of the cooling aperture are defined by the following expression:

$$\frac{D 1}{{d}_{h}} < 30 .$$

The turbine blade assembly of any preceding clause, wherein the first side defines a first side axis as projected onto a two-dimensional plane of the exterior surface; wherein an adjacent cooling hole angle (β) is defined as an angle between the first side axis and the cooling hole axis; and wherein the adjacent cooling hole angle (β) is less than 110 degrees (110°).

The turbine blade assembly of any preceding clause, wherein the at least one metering hole defines a minimum hydraulic diameter (dₕ) for the cooling aperture; wherein the cooling hole is one of a row of cooling holes, with the row of cooling holes defining the cooling hole axis, wherein a projected axis is provided at the diffuser outlet nearest to the row of cooling holes and arranged parallel to the cooling hole axis; wherein a cooling hole distance (D2) is defined as a distance between the cooling hole axis and the projected axis; and wherein the cooling hole distance (D2) and the minimum hydraulic diameter (dₕ) are defined by the following expression:

$$\frac{D 2}{{d}_{h}} < 20 .$$

The turbine blade assembly of any preceding clause, further comprising a set of bodies at the diffuser outlet and separating the diffuser outlet into a set of outlet portions.

The turbine blade assembly of any preceding clause, further comprising a cooling hole in the outer wall, the cooling hole spaced from the cooling aperture, the cooling hole having an inlet, an outlet, and a cooling hole passage extending therebetween and defining a cooling hole axis; wherein a total length (Lₜ) is defined as a summation of an arclength (Lₐ) defined along the outer edge and a minimum length (Lₘ) defined between the diffuser outlet and the cooling hole axis; wherein a total metal surface length (MSLₜ) is defined as the summation of a metal arclength (MSLₐ) defined by the set of bodies and a minimum length (MSLₘ) defined as the minimum length from the diffuser outlet to the outlet of the cooling hole; and wherein the total length (Lₜ) and the total metal surface length (MSLₜ) are defined by the following expression:

$$\frac{{MSL}_{t}}{{L}_{t}} < 0.5 .$$

A turbine blade assembly for a gas turbine engine, the turbine blade assembly comprising: an airfoil having an outer wall defining an interior, the outer wall having an interior surface facing the interior and an exterior surface opposite the interior surface; a cooling circuit at least partially defined by the interior to provide a flow of cooling fluid; and a cooling aperture fluidly coupled to the cooling circuit, the cooling aperture comprising: a cavity defining a volume; at least one metering hole that fluidly couples the cooling circuit and the cavity; a diffuser outlet exhausting from the cavity at the exterior surface and extending between a first opposing end and a second opposing end; a first side meeting the diffuser outlet at the first opposing end; and a second side meeting the first side at a junction, and the second side meeting the diffuser outlet at the second opposing end; wherein a first axis is defined extending from the junction to the first opposing end and projected onto a two-dimensional plane of the exterior surface; wherein a second axis is defined extending from the junction to the second opposing end and projected onto the two-dimensional plane; and wherein a cavity angle (α) is defined as an angle between the first axis and the second axis, and wherein the cavity angle (α) is greater than or equal to 75° and less than or equal to 135°.

The turbine blade assembly of any preceding clause, wherein the at least one metering hole defines a minimum hydraulic diameter (dₕ) for the cooling aperture; wherein an outlet edge distance (d_{edge}) defined as a minimum distance between the diffuser outlet and a nearest edge of the exterior surface; and wherein the outlet edge distance (d_{edge}) and the minimum hydraulic diameter (dₕ) of the cooling aperture are defined by the following expression:

$$0 \leq \frac{{d}_{edge}}{{d}_{h}} \leq 30 .$$

The turbine blade assembly of any preceding clause, further comprising at least one pin in the cavity; wherein the diffuser outlet includes an inner edge spaced from an outer edge, with the inner edge and the outer edge extending between the first opposing end and the second opposing end; wherein the outer edge comprises an inner section defined by the inner 50% of a length of the outer edge, being spaced from each of the first opposing end and the second opposing end by 25% of the length of the outer edge; wherein a junction axis is defined extending from the junction to any portion of the inner section and projected onto the two-dimensional plane; and wherein the at least one pin occupies greater than or equal to 30% and less than or equal to 70% of a length of the junction axis defined extending from the junction to at least one position along the length of the inner section and projected onto the two-dimensional plane.

The turbine blade assembly of any preceding clause, wherein each metering hole of the at least one metering hole comprises a center point and defines a minimum hydraulic diameter (dₕ); wherein a junction axis is defined extending from the junction equidistant between the first side and the second side and projected onto the two-dimensional plane; wherein a perpendicular axis is defined perpendicular to the junction axis, and wherein the perpendicular axis defines a midpoint; and wherein the center point for each metering hole of the at least one metering hole is located less than or equal to 5 minimum hydraulic diameters (dₕ) of the midpoint.

The turbine blade assembly of any preceding clause, wherein the at least one metering hole comprises a pair of metering holes as a first metering hole defining a first center point and a second metering hole defining a second center point; wherein a spacing distance(s) is defined as a distance between the first center point and the second center point; wherein a minimum hydraulic diameter (dₕ) of the cooling aperture is defined as an average of the minimum hydraulic diameters of the first metering hole and the second metering hole; and wherein the minimum hydraulic diameter (dₕ) of the cooling aperture and the spacing distance(s) are defined by the following expression:

$$0.1 \leq \frac{{d}_{h}}{s} \leq 0.70 .$$

The turbine blade assembly of any preceding clause, wherein the cavity is at least partially defined between an outer surface and an inner surface, and wherein at least a portion of the outer surface and at least a portion of the inner surface curve toward the exterior surface such that at least a portion of the cavity is non-planar.

What is claimed is:

1. A turbine blade assembly for a gas turbine engine, the turbine blade assembly comprising:
an airfoil having an outer wall defining an interior, the outer wall having an interior surface facing the interior and an exterior surface opposite the interior surface;
a cooling circuit in the interior to provide a flow of cooling fluid; and
a cooling aperture in the outer wall and fluidly coupled to the cooling circuit, the cooling aperture comprising:
a cavity in the outer wall, the cavity formed at least partially between a first side and a second side that meet at a junction;
at least one metering hole in the outer wall that fluidly couples the cooling circuit and the cavity; and
a diffuser outlet exhausting from the cavity at the exterior surface, the diffuser outlet having an inner edge meeting an outer edge at opposing ends at the first side and the second side;
wherein a distance between the first side and the second side increases in a direction extending from the junction to the diffuser outlet; and
wherein the inner edge and the outer edge have a concave curvature relative to the junction.

2. The turbine blade assembly of claim 1, wherein the at least one metering hole defines a minimum hydraulic diameter (dₕ) of the cooling aperture;
wherein an outlet edge distance (d_{edge}) defined as a minimum distance between the diffuser outlet and a nearest edge of the exterior surface; and
wherein the outlet edge distance (d_{edge}) and the minimum hydraulic diameter (dₕ) of the cooling aperture are defined by the following expression:
$$0 \leq \frac{{d}_{edge}}{{d}_{h}} \leq 30 .$$

3. The turbine blade assembly of claim 1, wherein the cooling aperture further includes a closed end at the junction.

4. The turbine blade assembly of claim 1, further comprising at least one film hole in the outer wall;
wherein the at least one metering hole defines a minimum hydraulic diameter (dₕ) for the cooling aperture;
wherein the cooling aperture is spaced from the at least one film hole by a film hole radial distance (d_{radial}) defined as a minimum distance between the at least one film hole and the diffuser outlet; and
wherein the film hole radial distance (d_{radial}) and the minimum hydraulic diameter (dₕ) of the cooling aperture are defined by the following expression:
$$0 \leq \frac{{d}_{radial}}{{d}_{h}} \leq 30 .$$

5. The turbine blade assembly of claim 1, further comprising at least one pin in the cavity;
wherein the outer edge comprises an inner section defined by the inner 50% of a length of the outer edge, being spaced from each of the opposing ends by 25% of the length of the outer edge;
wherein a junction axis is defined extending from the junction to any portion of the inner section and projected onto a two-dimensional plane of the exterior surface; and
wherein the at least one pin occupies greater than or equal to 30% and less than or equal to 70% of a length of the junction axis defined extending from the junction to at least one position along the length of the inner section and projected onto the two-dimensional plane.

6. The turbine blade assembly of claim 1, wherein the first side meets the diffuser outlet at a first opposing end and the second side meets the diffuser outlet at a second opposing end;
wherein a first axis is defined extending from the junction to a first point at which the first side meets the diffuser outlet at the first opposing end and projected onto a two-dimensional plane of the exterior surface;
wherein a second axis is defined extending from the junction to a second point at which the second side meets the diffuser outlet at the second opposing end and projected onto the two-dimensional plane; and
wherein a cavity angle (α) is defined as an angle between the first axis and the second axis, and wherein the cavity angle (α) is greater than or equal to 75° and less than or equal to 135°.

7. The turbine blade assembly of claim 1, wherein the diffuser outlet defines an outlet width (Ow);
wherein the diffuser outlet includes a first linear portion extending from a first opposing end and a second linear portion extending from a second opposing end, with a curved portion extending between the first linear portion to the second linear portion;
wherein a radius of curvature (R) is defined as a radius of a curvature defined equidistant between the inner edge and the outer edge for the curved portion; and
wherein the radius of curvature (R) and the outlet width (Ow) are defined by the following expression:
$$3 \leq \frac{R}{Ow} \leq 10 .$$

8. The turbine blade assembly of claim 1, wherein the inner edge defines a midpoint, and defines a midpoint axis extending from the junction to the midpoint;
wherein the cavity is further defined between an inner surface spaced from an outer surface in the outer wall;
wherein at least a portion of the inner surface and a portion of the outer surface are planar and arranged parallel to one another, defining a virtual plane equidistant from the portion of the inner surface and the portion of the outer surface that are planar and arranged parallel to one another; and
wherein a curvature angle is defined between the midpoint axis and a projection of the midpoint axis along the virtual plane, where the curvature angle is greater than or equal to 1° and less than or equal to 10°.

9. The turbine blade assembly of claim 1, further comprising a cooling hole in the outer wall, the cooling hole spaced from the cooling aperture, the cooling hole having an inlet, an outlet, and defining a cooling hole axis.

10. The turbine blade assembly of claim 9, the at least one metering hole defines a minimum hydraulic diameter (dₕ) for the cooling aperture;
wherein an adjacent cooling hole distance (D1) is defined as a minimum distance between the diffuser outlet and the outlet for the cooling hole; and
wherein the adjacent cooling hole distance (D1) and the minimum hydraulic diameter (dₕ) of the cooling aperture are defined by the following expression:
$$\frac{D 1}{{d}_{h}} < 30 .$$

11. The turbine blade assembly of claim 9, wherein the first side defines a first side axis as projected onto a two-dimensional plane of the exterior surface;
wherein an adjacent cooling hole angle (β) is defined as an angle between the first side axis and the cooling hole axis; and
wherein the adjacent cooling hole angle (β) is less than 110 degrees (110°).

12. The turbine blade assembly of claim 9, wherein the at least one metering hole defines a minimum hydraulic diameter (dₕ) for the cooling aperture;
wherein the cooling hole is one of a row of cooling holes, with the row of cooling holes defining the cooling hole axis,
wherein a projected axis is provided at the diffuser outlet nearest to the row of cooling holes and arranged parallel to the cooling hole axis;
wherein a cooling hole distance (D2) is defined as a distance between the cooling hole axis and the projected axis; and
wherein the cooling hole distance (D2) and the minimum hydraulic diameter (dₕ) are defined by the following expression:
$$\frac{D 2}{{d}_{h}} < 20 .$$

13. The turbine blade assembly of claim 1, further comprising a set of bodies at the diffuser outlet and separating the diffuser outlet into a set of outlet portions.

14. The turbine blade assembly of claim 13, further comprising a cooling hole in the outer wall, the cooling hole spaced from the cooling aperture, the cooling hole having an inlet, an outlet, and a cooling hole passage extending therebetween and defining a cooling hole axis;
wherein a total length (Lₜ) is defined as a summation of an arclength (Lₐ) defined along the outer edge and a minimum length (Lₘ) defined between the diffuser outlet and the cooling hole axis;
wherein a total metal surface length (MSLₜ) is defined as the summation of a metal arclength (MSLₐ) defined by the set of bodies and a minimum length (MSLₘ) defined as the minimum length from the diffuser outlet to the outlet of the cooling hole; and
wherein the total length (Lₜ) and the total metal surface length (MSLₜ) are defined by the following expression:
$$\frac{{MSL}_{t}}{{L}_{t}} < 0.5 .$$

15. A turbine blade assembly for a gas turbine engine, the turbine blade assembly comprising:
an airfoil having an outer wall defining an interior, the outer wall having an interior surface facing the interior and an exterior surface opposite the interior surface;
a cooling circuit at least partially defined by the interior to provide a flow of cooling fluid; and
a cooling aperture fluidly coupled to the cooling circuit, the cooling aperture comprising:
a cavity defining a volume;
at least one metering hole that fluidly couples the cooling circuit and the cavity;
a diffuser outlet exhausting from the cavity at the exterior surface and extending between a first opposing end and a second opposing end;
a first side meeting the diffuser outlet at the first opposing end; and
a second side meeting the first side at a junction, and the second side meeting the diffuser outlet at the second opposing end;
wherein a first axis is defined extending from the junction to the first opposing end and projected onto a two-dimensional plane of the exterior surface;
wherein a second axis is defined extending from the junction to the second opposing end and projected onto the two-dimensional plane; and
wherein a cavity angle (α) is defined as an angle between the first axis and the second axis, and wherein the cavity angle (α) is greater than or equal to 75° and less than or equal to 135°.

16. The turbine blade assembly of claim 15, wherein the at least one metering hole defines a minimum hydraulic diameter (dₕ) for the cooling aperture;
wherein an outlet edge distance (d_{edge}) defined as a minimum distance between the diffuser outlet and a nearest edge of the exterior surface; and
wherein the outlet edge distance (d_{edge}) and the minimum hydraulic diameter (dₕ) of the cooling aperture are defined by the following expression:
$$0 \leq \frac{{d}_{edge}}{{d}_{h}} \leq 30 .$$

17. The turbine blade assembly of claim 15, further comprising at least one pin in the cavity;
wherein the diffuser outlet includes an inner edge spaced from an outer edge, with the inner edge and the outer edge extending between the first opposing end and the second opposing end;
wherein the outer edge comprises an inner section defined by the inner 50% of a length of the outer edge, being spaced from each of the first opposing end and the second opposing end by 25% of the length of the outer edge;
wherein a junction axis is defined extending from the junction to any portion of the inner section and projected onto the two-dimensional plane; and
wherein the at least one pin occupies greater than or equal to 30% and less than or equal to 70% of a length of the junction axis defined extending from the junction to at least one position along the length of the inner section and projected onto the two-dimensional plane.

18. The turbine blade assembly of claim 15,
wherein each metering hole of the at least one metering hole comprises a center point and defines a minimum hydraulic diameter (dₕ);
wherein a junction axis is defined extending from the junction equidistant between the first side and the second side and projected onto the two-dimensional plane;
wherein a perpendicular axis is defined perpendicular to the junction axis, and wherein the perpendicular axis defines a midpoint; and
wherein the center point for each metering hole of the at least one metering hole is located less than or equal to 5 minimum hydraulic diameters (dₕ) of the midpoint.

19. The turbine blade assembly of claim 18, wherein the at least one metering hole comprises a pair of metering holes as a first metering hole defining a first center point and a second metering hole defining a second center point;
wherein a spacing distance(s) is defined as a distance between the first center point and the second center point;
wherein a minimum hydraulic diameter (dₕ) of the cooling aperture is defined as an average of the minimum hydraulic diameters of the first metering hole and the second metering hole; and
wherein the minimum hydraulic diameter (dₕ) of the cooling aperture and the spacing distance(s) are defined by the following expression:
$$0.1 \leq \frac{{d}_{h}}{s} \leq 0.70 .$$

20. The turbine blade assembly of claim 15, wherein the cavity is at least partially defined between an outer surface and an inner surface, and wherein at least a portion of the outer surface and at least a portion of the inner surface curve toward the exterior surface such that at least a portion of the cavity is non-planar.
